(19) United States
(12) Patent Application Publication
(10) Pub. No.: US 2006/0143172 A1
(43) Pub. Date: Jun. 29, 2006

(54) Mask processing device, mask processing method, program and mask

(76) Inventors: Isao Ashida, Tokyo (JP); Kohichi Nakayama, Tokyo (JP)

Correspondence Address: Trexler Bushnell Giangiorgi Blackstone & Marr, 105 W Adams Street, 36th Floor, Chicago, IL, 60603, US

(21) Appl. No.: 10/543,968

(22) PCT Filed: Feb. 4, 2004
(86) PCT No.: PCT/JP04/01118

§ 371 Date: Jul. 26, 2005

(30) Foreign Application Priority Data
Feb. 6, 2003 (JP) 2003-068875

(51) Int. Cl. G06F 17/30

(52) U.S. Cl. 707/6

(57) ABSTRACT

Based on design data 151 and mask characteristic data 152 indicating at least the characteristics of a complementary stencil mask, generating alignment marks, designing membrane shapes, performing PUF division and boundary processing, complementarily dividing the mask, stitching, arranging complementary patterns, verifying pattern shapes, making corrections in the membrane, configuring the mask, verifying exposure, making corrections by inverting the mask, verifying the results of correction, converting the data, and thereby generating the drawing membrane data and drawing pattern data.

### TECHNICAL FIELD

In recent years, along with miniaturization of semiconductor elements, in order to overcome the resolution limit of optical systems, micromachining technology using electron beams, ion beams, and other charged particle beams to draw circuit patterns have been developed

In the conventional so-called direct drawing type electron beam exposure method, the finer the pattern, the larger the data scale, the longer the drawing time, and the lower the productivity as a result. For this reason, an electron beam/ion beam exposure apparatus for focusing an electron beam/ion beam on a transfer mask having predetermined patterns so as to form patterns on a wafer is known.

As these technology, for example electron beam projection lithography (EPL) (refer to for example H. C. Pfeiffer, Jpn. J. Appl. Phys. 34, 6658 (1995)), low energy electron beam proximity projection lithography (LEEPL) (refer to for example T. Utsumi, U.S. Pat. No. 5,831,272 (Nov. 3, 1998)), or ion projection lithography (IPL) (refer to for example H. Loeschner et al., Vac. SciTechnol. B19, 2520 (2001)), etc. are known.

An electron beam transmission mask used in the above-explained exposure apparatus is for example a stencil mask comprised of a thin film (also referred to as a “membrane”) having a thickness of about 100 nm to 10 μm having a pattern of openings formed in it.

However, since holes are made in the membrane, there are patterns which cannot be formed or are hard to be formed such as donut-shaped patterns (whose center portions drop off) and a leaf patterns (of cantilever structures, so unstable).

Further, where using a very thin membrane, it suffers from the disadvantage that forming holes in the membrane cause changes in the state of internal stress and changes in the pattern shapes.

For this reason, in order to prepare a stencil mask used in a charged particle beam exposure apparatus, a data processing apparatus and method having new functions different from conventional data processing for a mask using light have been demanded.

### DISCLOSURE OF THE INVENTION

The present invention was made in consideration with such circumstances and has as an object thereof to provide a mask processing apparatus, a mask processing method, a program and a mask able to easily prepare a mask used in a charged particle beam exposure apparatus.

To achieve the above object, a mask processing apparatus of a first aspect of the present invention provides a mask processing apparatus generating complementary stencil mask data, having a complementary dividing means for complementarily dividing design data for each predetermined processing unit to generate complementarily divided patterns based on the design data and mask characteristic data indicating at least the characteristics of the complementary stencil masks and a mask data generating means for generating the complementary stencil mask data based on the complementarily divided patterns generated by the complementary dividing means and mask characteristic data.

According to the mask processing apparatus of the first aspect of the present invention, the complementary dividing means complementarily divides the design data for each predetermined processing unit to generate complementarily divided patterns based on the design data and mask characteristic data indicating at least the characteristics of the complementary stencil masks.

The mask data generating means generates the complementary stencil mask data based on the complementarily divided patterns generated by the complementary dividing means and the mask characteristic data.

Further, to achieve the above object, a mask processing method according to a second aspect of the present invention provides a mask processing method of a mask processing apparatus for generating complementary stencil mask data, including a first step of complementarily dividing design data for each predetermined processing unit to generate complementarily divided patterns based on the design data and mask characteristic data indicating at least the characteristics of complementary stencil masks and a second step of generating complementary stencil mask data based on the complementarily divided patterns generated in the first step and the mask characteristic data.

Further, to achieve the above object, a mask processing method according to a third aspect of the present invention provides a mask processing method of a mask processing apparatus for generating complementary stencil mask data, comprising a first step of complementarily dividing design data for each predetermined processing unit to generate complementarily divided patterns based on design data and mask characteristic data including at least beam position data of beams and device characteristic data concerning the characteristic of a stencil mask generation device for generating complementary stencil masks and indicating the characteristics of the complementary stencil masks, a second step of generating membrane data for drawing the shape of the membrane in the complementary stencil masks based on the design data and the mask characteristic data, a third step of arranging the complementarily divided patterns at predetermined positions of the stencil mask based on the complementarily divided patterns generated for each predetermined processing unit by the first step and the mask characteristic data, a fourth step of verifying whether or not defect patterns have been generated on the complementary stencil masks based on the complementarily divided patterns arranged at the third step, a fifth step of performing displacement correction processing on the complementarily divided patterns using internal stress of the membrane in the complementary stencil masks, a sixth step of performing the displacement correction processing for the complementarily divided patterns using the mechanical characteristics of a mask member of the complementary stencil masks, a seventh step of verifying whether or not the complementarily divided patterns coincide with patterns in the design data by a plurality of exposures, an eighth step of performing the displacement correction processing on the complementarily divided patterns using front/back inversion of the complementary stencil masks to generate complementary stencil mask data, a ninth step of verifying whether or not the complementarily divided patterns coincide with patterns in the design data based on the complementary stencil mask data generated by the eighth step and the design data, and a 10th step of generating drawing membrane data for making the stencil mask generation device draw the membrane and draw the complementarily divided patterns in the membrane based on the membrane data, the complementary stencil mask data, and the device characteristic data.

Further, to achieve the above object, a program according to a fourth aspect of the present invention provides a program to be executed by an information processing apparatus comprising a first routine of complementarily dividing design data for each predetermined processing unit to generate complementarily divided patterns based on the design data and mask characteristic data indicating at least the characteristics of complementary stencil masks and a second routine of generating complementary stencil mask data based on the complementarily divided patterns generated at the first routine and the mask characteristic data.

Further, to achieve the above object, a program according to a fifth aspect of the present invention provides a program to be executed by an information processing apparatus comprising a first routine of complementarily dividing design data for each predetermined processing unit to generate complementarily divided patterns based on the design data and mask characteristic data including at least beam position data of beams and device characteristic data concerning the characteristics of a stencil mask generation device for generating the complementary stencil masks and indicating the characteristics of the complementary stencil masks, a second routine of generating membrane data for drawing the shape of the membrane in the complementary stencil masks based on the design data and the mask characteristic data, a third routine of arranging the complementarily divided patterns at predetermined positions of the stencil mask based on the complementarily divided patterns generated for each predetermined processing unit by the first routine and the mask characteristic data, a fourth routine of verifying whether or not a defect pattern is generated on the complementary stencil masks based on the complementarily divided patterns arranged in the third routine, a fifth routine of performing displacement correction processing on the complementarily divided patterns using internal stress of the membrane in the complementary stencil masks, a sixth routine of performing displacement correction processing on the complementarily divided patterns using mechanical characteristics of a mask member of the complementary stencil masks, a seventh routine of verifying whether or not the complementarily divided patterns coincide with patterns in the design data by a plurality of exposures, an eighth routine of generating the complementary stencil mask data by performing displacement correction processing on the complementarily divided patterns using front/back inversion of the complementary stencil masks, a ninth routine of verifying whether or not the complementarily divided patterns coincide with patterns in the design data based on the complementary stencil mask data generated by the eighth routine and the design data, and a 10th routine of generating drawing membrane data for making the stencil mask generation device draw the membrane and draw the complementarily divided patterns in the membrane based on the membrane data, the complementary stencil mask data, and the device characteristic data.

Further, to achieve the above object, the sixth aspect of the present invention is generated based on the complementary stencil mask data generated by the mask processing apparatus.

Further, to achieve the above object, the seventh aspect of the present invention is generated by the stencil mask generation device based on the drawing membrane data and the drawing pattern data generated by the mask processing apparatus.

### BRIEF DESCRIPTION OF THE DRAWINGS

FIG. 1 is a diagram of an embodiment of a mask processing system including a mask processing apparatus according to the present invention.

FIG. 2A to FIG. 2F are conceptual views for explaining operation of the mask processing system shown in FIG. 1.

FIG. 3A to FIG. 3F are diagrams showing another specific example of a mask pattern and complementary division shown in FIG. 2A to FIG. 2F.

FIG. 4A to FIG. 4C are diagrams for explaining the operation of the mask processing system shown in FIG. 1.

FIG. 5A to FIG. 5C are diagrams for explaining the complementary division when using four complementary masks.

FIG. 6A is a view of a specific example of a complementary stencil mask, that is,-a first complementary stencil mask.

FIG. 6B is a view of a specific example of complementary stencil mask, that is, a second complementary stencil mask.

FIG. 7 is an overall view of the complementary stencil mask shown in FIG. 6A.

FIG. 8 is an enlarged view of the vicinity of the center of a membrane c3 shown in FIG. 7.

FIG. 9 is a sectional view of stencil mask c1 shown in FIG. 7.

FIG. 10 is a perspective view enlarging one of the membrane divided regions and beams on the periphery of that.

FIG. 11 is a sectional view enlarging the vicinity of the beams illustrated in FIG. 10.

FIG. 12 is a hardware like block diagram of an embodiment of the mask processing apparatus according to the present invention.

FIG. 13 is a diagram showing an embodiment of software like functional blocks of the mask processing apparatus shown in FIG. 1.

FIG. 14 is a diagram for explaining an alignment mark.

FIG. 15 is a diagram for explaining a relationship between design data and a mask.

FIG. 16A to FIG. 16B are diagrams showing specific examples of the mask according to the present embodiment.

FIG. 17A to FIG. 17D are diagrams for explaining a unit field concerning the mask.

FIG. 18A is a diagram enlarging part of FIG. 17A.

FIG. 18B is a diagram enlarging part of FIG. 17C.

FIG. 19A to FIG. 19F are diagrams for explaining boundary processing.

FIG. 20A to FIG. 20D are diagrams for explaining the boundary processing.

FIG. 21 is a diagram extracting the smallest pattern to be multiply exposed among sections of the stencil mask shown in FIG. 8.

FIG. 22 is a diagram for explaining a section in which individual PUFs (blocks) can be arranged in the smallest pattern shown in FIG. 21.

FIG. 23 is a diagram for explaining the section which can be arranged including position information of the beams of the pattern shown in FIG. 22.

FIG. 24 is a diagram showing a specific example of layout.

FIG. 25A to FIG. 25C are diagrams for explaining stitching precision at the multiple exposure treatment.

FIG. 26A to FIG. 26C are diagrams for explaining stitching.

FIG. 27A to FIG. 27C are diagrams for explaining the operation of stitching.

FIG. 28 is a diagram for explaining processing for detection of a donut pattern of a pattern shape verification unit.

FIG. 29 is a diagram for explaining processing for detection of a leaf pattern of a pattern shape verification unit.

FIG. 30 is a diagram for explaining processing for detection of a leaf pattern of a pattern shape verification unit.

FIG. 31 is a diagram for explaining processing for detection of a leaf pattern of a pattern shape verification unit.

FIG. 32 is a diagram for explaining distortion due to a hole formed in the stencil mask.

FIG. 33A is a diagram showing a hole (pattern) having a curved contour as a result of correction processing by the results of stress analysis.

FIG. 33B is a diagram showing a pattern for which step shapes are corrected as a result of correction processing.

FIG. 34 is a diagram showing a specific example of the correction processing of an in-membrane correction unit.

FIG. 35A is a sectional view schematically showing a stencil mask at the time of preparation of a mask.

FIG. 35B is a sectional view schematically showing a stencil at the time of usage of a mask.

FIG. 36A to FIG. 36B are diagrams for explaining correction of distortion.

FIG. 37 is a flow chart showing the operation of a mask processing system 100 shown in FIG. 1.

FIG. 38 is a flow chart for explaining the operation of the mask processing apparatus shown in FIG. 1.

FIG. 39 is a flow chart for explaining the operation of the mask processing apparatus shown in FIG. 1.

### BEST MODE FOR CARRYING OUT THE INVENTION

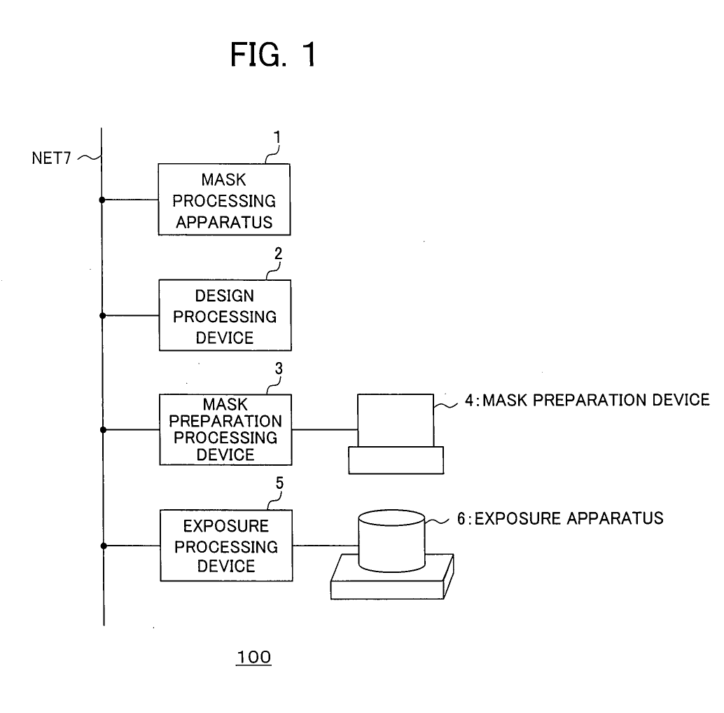

FIG. 1 is a diagram showing an embodiment of a mask processing system including a mask processing apparatus according to the present invention.

A mask processing system 100 has, for example as shown in FIG. 1, a mask processing apparatus 1, design processing device 2, mask preparation processing device 3, mask preparation device 4, exposure processing device 5, and exposure apparatus 6.

The mask processing apparatus 1, design processing device 2, mask preparation processing device 3, mask preparation device 4, exposure processing device 5, and exposure apparatus 6 are connected by a communication network NET7. The mask processing apparatus 1 corresponds to the mask processing apparatus and the information processing device according to the present invention. The mask preparation processing device 3 and the mask preparation device 4 correspond to the stencil mask generation device according to the present invention.

The design processing device 2 generates for example desired design data of a semiconductor integrated circuit and outputs the same via the communication network NET7 to the mask processing apparatus 1.

The mask processing apparatus 1 generates complementary stencil mask data, in more detail, drawing membrane data, drawing pattern data, etc. explained later based on for example the design data output from the design processing device 2, the mask characteristic data indicating the characteristics of the stencil mask including device characteristic parameters concerning the mask preparation device 4, device characteristic parameters concerning the exposure apparatus 6, etc., and outputs the same via the network NET7 to the mask preparation processing device 3.

The mask preparation processing device 3 controls the mask preparation device 4 to make the mask preparation device 4 actually generate a desired mask based on the drawing membrane data and the drawing pattern data etc. output from the mask processing apparatus 1.

The exposure processing device 5 controls the exposure apparatus 6 in accordance with a predetermined exposure processing step.

The exposure apparatus 6 emits for example a low energy electron beam via the complementary stencil masks generated at the mask preparation device 4 under the control of the exposure processing device 5 to expose circuit patterns in accordance with the desired design data onto the wafer. The circuit patterns on the wafer are etched by a not illustrated etching device, whereby desired circuit patterns are generated. For example, in the exposure apparatus 6 of the present embodiment, when using a low energy electron beam, a gap of about 50 μm is provided between the wafer and the mask, and the mask is exposed at equal magnification.

At this time, the electron beam cannot pass through the object, therefore use is made of a for example silicon (Si), diamond, or SiC stencil mask having holes formed in the mask.

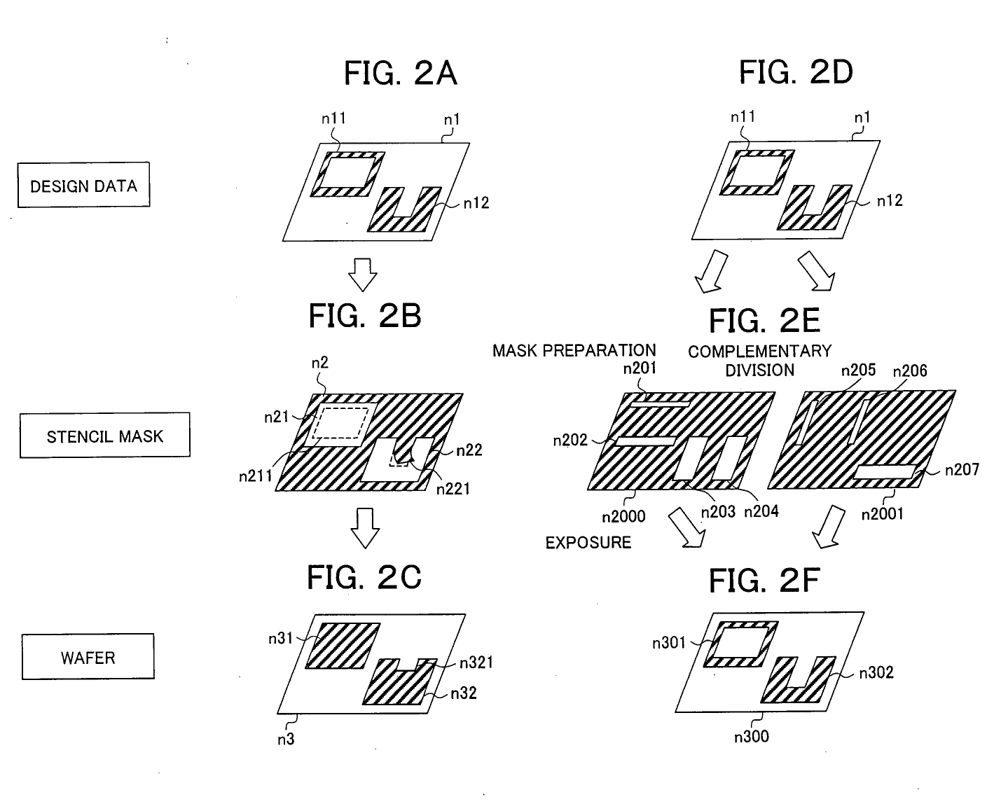

FIG. 2A to FIG. 2F are conceptual views for explaining the operation of the mask processing system shown in FIG. 1. This will be explained with reference to an example of a donut pattern and leaf pattern which become problems when generating a stencil mask.

For example, in the case of design data n1 as shown in FIG. 2A, a donut pattern n11 cannot support a pattern n211 in the center as shown in FIG. 2B and therefore results in a dropout shape n21 in the case of a simply formed stencil mask n2. When using that stencil mask n2 for exposure, a pattern n31 with the center dropped out is formed on a wafer n3 as shown in FIG. 2C.

Further, a leaf pattern n12 as shown in FIG. 2A has only a small part supporting the center projection n211 as shown in FIG. 2B in the case of a thin stencil mask n22, so deformation such as drooping occurs due to gravity, stress concentrates at the fulcrum, and breakage may result. When using this stencil mask n2 for exposure, for example a pattern n32 having a shape with a deformed center n321 is formed as shown in FIG. 2C.

On the other hand, in the mask processing system 100 according to the present embodiment, in the case of the design data n1 as shown in FIG. 2D, by individually complementarily dividing the mask patterns n21 and n22 to a plurality of patterns n201 to n207 on a plurality of masks n2000 and n2001 as shown in FIG. 2E and exposing the plurality of masks n2000 and n2001 a plurality of times, the desired patterns n301 and n302 can be formed on a wafer n300 as shown in FIG. 2F.

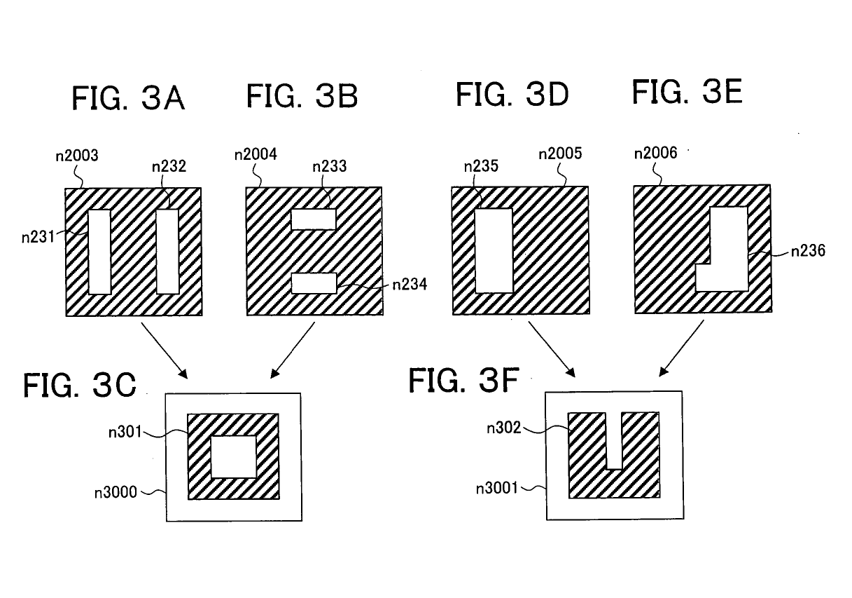

FIG. 3A to FIG. 3F are diagrams showing another specific example of the mask pattern and the complementary division shown in FIG. 2A to FIG. 2F.

Further, for example a donut pattern n11 shown in FIG. 2D is complementarily divided, patterns n231 and n232 are formed on a stencil mask n2003, and patterns n233 and n234 are formed on a stencil mask n2004 as shown in FIG. 3B. By multiply exposing the stencil masks n2003 and n2004, a pattern n301 having a desired donut shape is formed on a wafer n3000 as shown in FIG. 3C.

Further, the leaf pattern n12 shown in FIG. 2D is complementarily divided, for example a pattern n235 is formed on a stencil mask n2005, and a pattern n236 is formed on a stencil mask n2006 as shown in FIG. 3D and FIG. 3E. By multiply exposing the stencil masks n2005 and n2006, as shown in FIG. 3F, a pattern n302 having a desired donut shape-is formed on the wafer n3001.

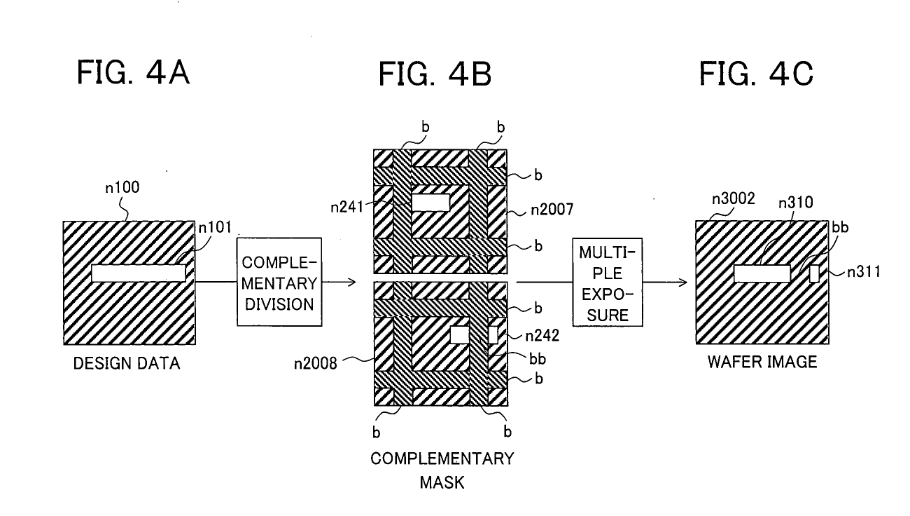

FIG. 4A to FIG. 4C are diagrams for explaining the operation of the mask processing system shown in FIG. 1.

For example, the mask processing system 100 uses a complementary beam (strut) mask giving a beam (strut) structure to realize the required precision of this complementary division, the formation of the mask, and the exposure and prevent the distortion and breakage of the mask due to a thin membrane.

For example, the pattern n101 in the design data n100 shown in FIG. 4A is divided to a plurality of complementary masks n2007 and n2008 equipped with the beams as a pattern n241 and a pattern n242 by the complementary division processing as shown in FIG. 4A. The complementary masks n2007 and n2008 are formed with pluralities of beams b in lattices. For this reason, if simply complementarily dividing a pattern without considering the positions of the beams b and a shown in FIG. 4A and FIG. 4C, the pattern n242 cannot be formed at a position bb corresponding to the beams b. When multiply exposing the wafer n3002 using these complementary masks n2007 and n2008, patterns n310 and n311 are formed due to the influence of the beams b as shown in FIG. 4C.

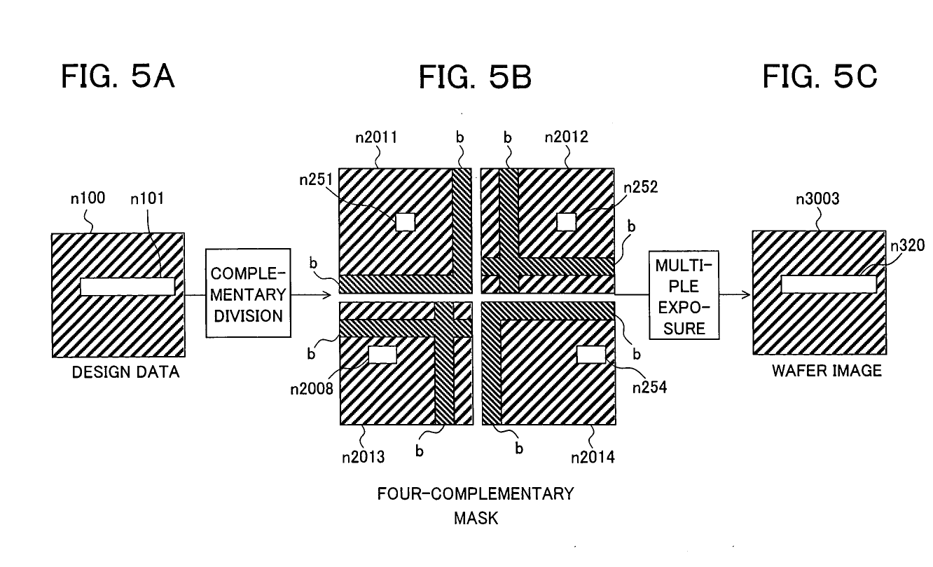

FIG. 5A to FIG. 5C are diagrams for explaining complementary division when using four complementary masks.

The pattern n101 in the design data n100 as shown in FIG. 5A is complementarily divided into patterns n251 to n254 at a plurality of, for example, four complementary masks n2011 to n2014. These complementary masks n2011 to n2014 are formed with beams b. These beams b are provided so that predetermined positions are exposed at least one time when the exposure apparatus 6 multiply exposes the patterns superposed slightly offset using the complementary masks n2011 to n2014. The exposure apparatus 6 can form perform multiple exposure while superimposing these complementary masks n2011 to n2014 offset so as to form a desired pattern n320 on a wafer n3003. Further, since the beams b are provided at predetermined positions, when the exposure apparatus 6 performs the multiplex exposure, there is no portion not irradiated in the complementary masks.

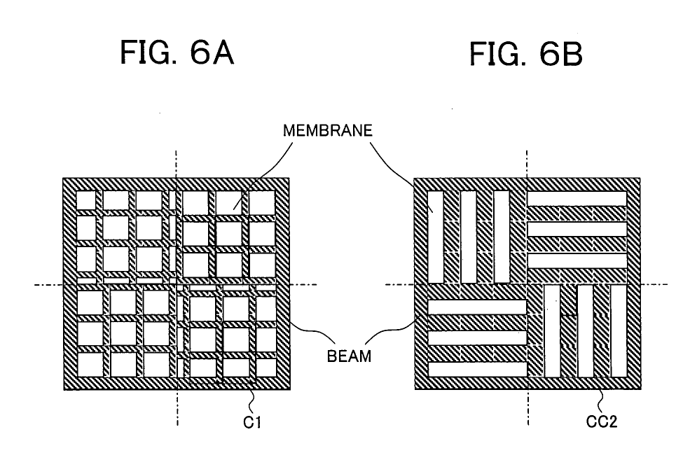

FIG. 6A is a diagram showing a specific example of a complementary stencil mask, that is, a first complementary stencil mask. FIG. 6B is a diagram showing a specific example of a complementary stencil mask, that is, a second complementary stencil mask.

Complementary stencil masks come in a plurality of types according to the beam positions and the layout positions of the membrane so as to satisfy predetermined conditions. For example, the first complementary stencil mask c1 is a mask in which beams are formed at predetermined positions in lattices in each of four sections as shown in FIG. 6A (also referred to as COSMOS-I), and the second complementary stencil mask cc2 is a mask in which beams are formed in predetermined directions parallel to each other in each of four sections as shown in FIG. 6B (also referred to as COSMOS-II).

Below, an explanation will be given of the first complementary stencil mask c1 (COSMOS-I) shown in FIG. 6A.

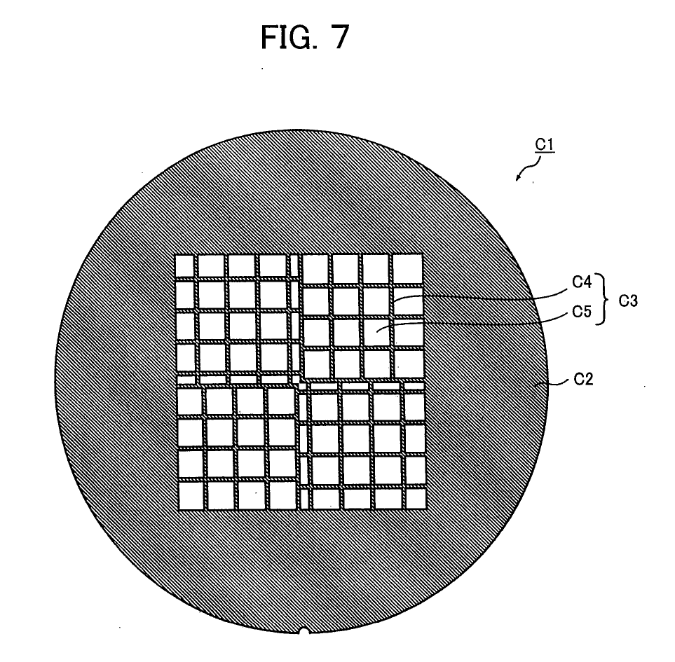

FIG. 7 is an overall view of the complementary stencil mask shown in FIG. 6A.

As shown in FIG. 7, the first complementary stencil mask (hereinafter, also referred to as a “mask” or a “stencil mask”) c1 is formed by using for example a silicon wafer c2. The center of the silicon wafer c2 is removed in a square shape, and a membrane c3 is formed in this part. A silicon wafer having a thick film on the periphery of a membrane c3 is used as a support frame (frame) for supporting the thin membrane c3.

The beams c4 are the parts remaining after forming a plurality of openings in the silicon wafer c2. Terminal ends of all beams c4 are connected to the frame or other beams c4. There is no portion where the beams c4 are disconnected.

Below, a square portion of the membrane c3 surrounded by the beams c4 will be defined as a “membrane divided region c5”. The beams c4 are provided with skirts of narrow widths parallel to the beams c4 at the membranes c3 at the two sides. In the membrane divided region c5, the part except the skirts will be defined as the “pattern region”. Further, a part combining the beams c4 and the skirts will be defined as a “beam zone”.

Next, an explanation will be given of the layout of the beams in the stencil mask shown in FIG. 7.

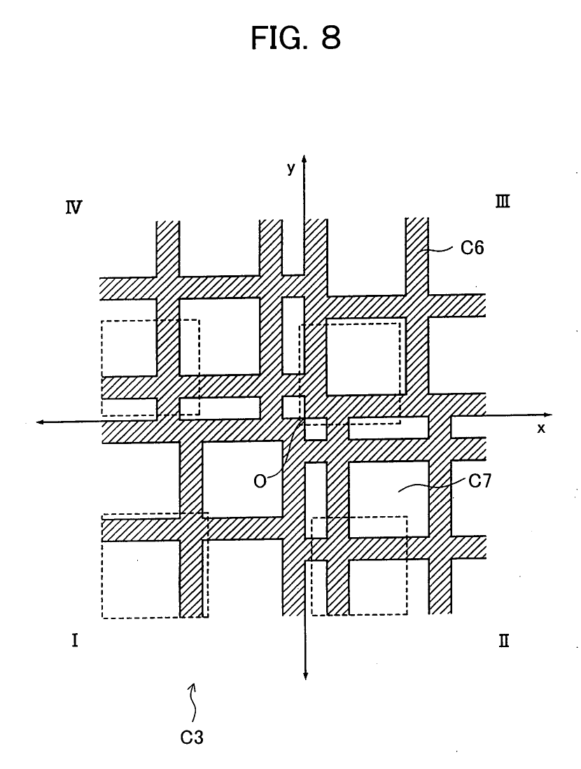

FIG. 8 is an enlarged diagram of the vicinity of the center of the membrane c3 shown in FIG. 7. In FIG. 8, the beam zones c6 are shown in place of the beams c4 shown in FIG. 7. The square part surrounded by the beam zones c6 is a pattern region c7.

Assuming that the center of the silicon wafer c2 shown in FIG. 7 is the origin O and the membrane c3 shown in FIG. 8 is an X-Y plane, the membrane c3 is divided to four regions by an x-axis and a y-axis. Below, these regions will be defined as sections I to IV.

The membrane c3 does not strictly have to be a square shape. So long as the sections I to IV have rectangular shapes having the x-axis and the y-axis as two sides or shapes near that, the lengths of all sides of sections I to IV do not have to completely coincide.

In each of sections I to IV, a plurality of beam zones c6 are arranged at equal intervals parallel to the x-axis. In the same way, a plurality of beam zones c6 are arranged in the sections I to IV at equal intervals parallel to the y-axis. The beams c4 of FIG. 7 are formed in these beam zones c6.

In the x-axis direction, the positions of the beam zones c6 parallel to the x-axis do not coincide between the adjacent section I and section II or between section III and section IV. In the same way, in the y-axis direction, the positions of the beam zones c6 parallel to the y-axis do not coincide between the adjacent section I and section IV or between section II and section III.

Among the four sections I to IV, the beam zones c6 contact both of the x-axis and the y-axis in only one set of sections on a diagonal line of the membrane c3. As shown in FIG. 8, among the four sections I to IV, the beam zones c6 is arranged at a boundary portion between the section I and the section IV (portion contacting the x-axis), and the beam zone c6 is arranged at a boundary portion between the section I and the section II (portion contacting the y-axis).

The beam zone c6 is arranged at a boundary portion between the section III and the section II (portion contacting the x-axis) existing on the diagonal line together with the section I, and the beam zone c6 is arranged at a boundary portion between, the section III and the section IV (portion contacting the y-axis).

Alternatively, in FIG. 8, the beam zones c6 may be arranged to contact both of the x-axis and the y-axis in only one set of sections (section II and section IV) on the diagonal line.

In the example shown in FIG. 8, in the section II and the section IV, the beam zones c6 are not formed along the boundary with the adjacent section. The terminal ends of the beam zones c6 of the section II and the section IV are connected to the beam zones c6 of the adjacent sections in T-shapes. The beam zones c6 of the section II and the section IV are arranged so as to satisfy constant conditions.

The interval between the beam zones c6, that is, the length of one side of a pattern region c7, is preferably a whole multiple of 3 or more when for example the width of the beam zone is 1.

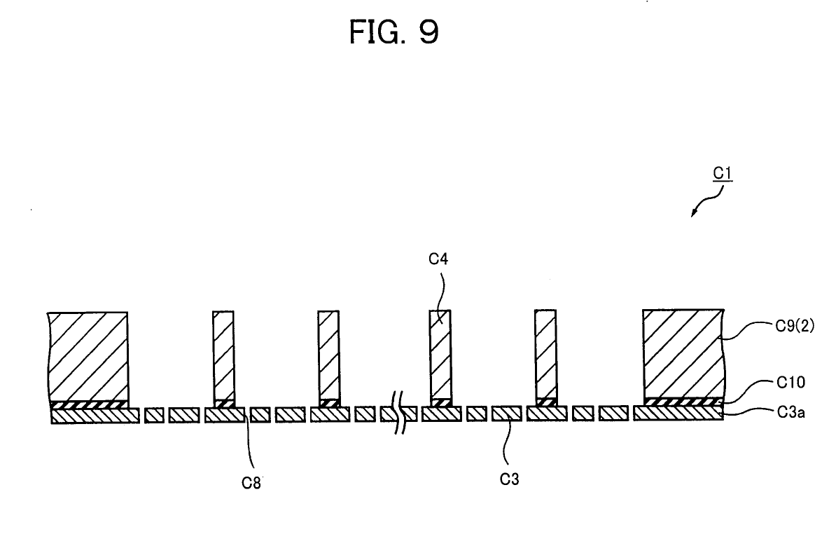

FIG. 9 is a sectional view of the stencil mask c1 shown in FIG. 7.

The membrane c3 of the stencil mask c1 is for example formed with holes c8 corresponding to the patterns as shown in FIG. 9. The membrane c3 is part of a membrane formation layer c3a. The silicon wafer c2 on the periphery of the membrane c3 forms a frame c9 for supporting the membrane c3. The beams c4 are formed at constant intervals on the plane of the membrane c3 on the frame c9 side. Note that a silicon oxide film c10 is formed as an etching stopper layer in the process of production of the stencil mask c1.

The stencil mask c1 is arranged so that the surface on the membrane c3 side becomes close to the wafer surface to which the patterns are transferred. When the stencil mask c1 is scanned by the electron beam from the frame c9 side, the electron beam passes through only the parts of the holes c8 so the patterns are transferred onto the resist on the wafer.

The stencil mask c1 according to the present embodiment cannot form holes 8 in the beam 4 parts. Accordingly, as explained above, the pattern is complementarily divided, and complementary patterns are formed in the sections I to IV shown in FIG. 7.

As explained above, when using the stencil mask c1 for exposure, first the stencil mask c1 and the wafer are fixed in place and the patterns of sections I to IV shown in FIG. 8 are transferred. Next, the stencil mask c1 and the wafer are relatively moved to arrange different sections of the stencil mask 1 on the transferred patterns of the sections I to IV. Usually, it is easier to move the wafer while leaving the stencil mask c1 fixed in place as it is.

After moving the wafer, the stencil mask c1 is again scanned by the electron beam. By repeating the above steps, multiple exposure is carried out four times so that the patterns of the four sections I to IV of the stencil mask c1 overlap. By this, patterns existing at the portions of the beams c4 are also complementary transferred to the resist.

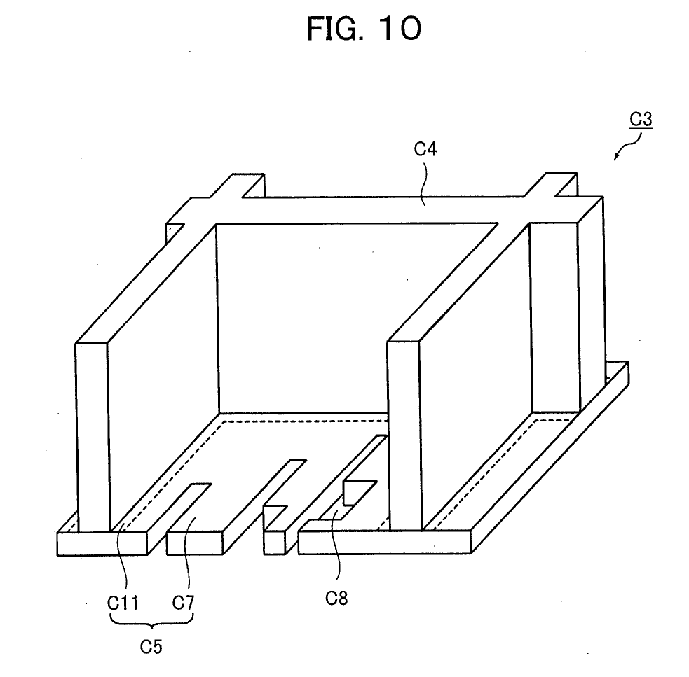

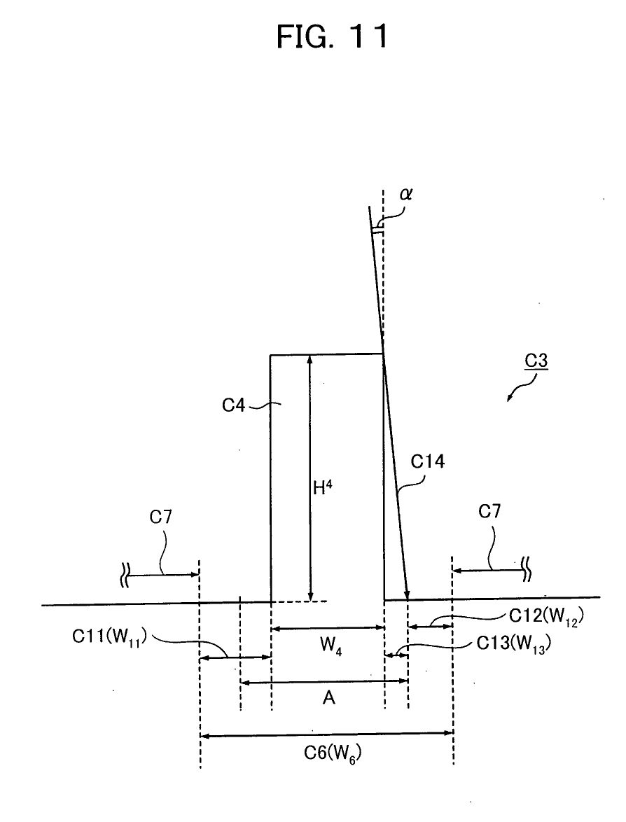

FIG. 10 is a perspective view enlarging one of the membrane divided regions c5 and the beams c4 on the periphery of the same.

The membrane c3 is divided to membrane divided regions c5 by the beams c4 as shown in FIG. 10. Holes c8 corresponding to the patterns cannot be formed at the beam c4 portions, but are formed in the parts of the membrane divided regions c5 of the membrane c3. In the membrane divided region c5 shown, the portion surrounded by the dotted line corresponds to the pattern region shown in FIG. 8.

In the membrane divided region c5, the outside portion of the pattern region c7 corresponds to the skirts c11. The portions formed by combining the beams c3 and the skirts c11 on both sides thereof correspond to the beam zones c6 shown in FIG. 8. In principle, the holes c8 are formed in the pattern region c7, but may be formed projecting out to parts of the skirts c11 in some cases as well.

FIG. 11 is a sectional view enlarging the vicinity of a beam c4 illustrated in FIG. 10.

As shown in FIG. 11, a width obtained by combining a width W4 of the beam c4 and widths W11 of the skirts c11 on both sides thereof is a width W6 of the beam zone c6. The width W4 of the beam c4 can be set to about for example 100 to 200 μm. Each skirt c11 is further divided to a margin c12 and a blank c13. The margin c12 is located on the pattern region c7 side, and the blank c13 is located on the beam c4 side.

Below, an explanation will be given of the margin c12 and the blank c13. When patterns do not completely fit in the pattern region c7, in principle holes 8 corresponding to patterns of the projecting portions are formed in other sections among the four sections I to IV of the stencil mask. The patterns are stitched together by multiple exposure.

However, when patterns project out from the pattern region c7 just a little, it is more advantageous if the patterns can be transferred without division by stitching the complementary patterns to one of the other sections I to IV. Especially, when a fine pattern having a particularly narrow line width, for example, a gate of a transistor, slightly projects out from the pattern region c7, if divided to complementary patterns, there is a high possibility of lowering the characteristics of the produced semiconductor device.

Therefore, the margin c12 enabling formation of holes c8 is provided on the periphery of the pattern region c7. The width W12 of the margin c12 can be freely set, but when the width W12 is made large, the original region for the patterns, that is, the pattern region c7, becomes smaller. Accordingly, the width W12 is set to for example about a few μm to tens of μm.

For example, according to the LEEPL, it is possible to finely change an incident angle α of the electron beam with respect to the stencil mask. The range of the incident angle α of the electron beam is usually about 0 to 10 mrad. When using an 8 inch wafer to form the stencil mask, the height H4 of the beams c4 becomes the 725 μm thickness of the 8-inch silicon wafer.

As shown in FIG. 11, when the electron beam c14 is obliquely incident upon the membrane c3, a region to which the electron beam c14 is not irradiated is formed in the vicinity of the beam c4. When the incident angle α of the electron beam c14 is 10 mrad at the maximum, the lowest required width W13 of the blank c13 is calculated as:
W13=10×10⁻³ (rad)×H(μm)=7.25 (μm)≈7(μm)
As described above, a hole c8 is not formed in a portion A formed by combining the beam c4 and the blank c13 on both sides.

The mask processing apparatus 1 according to the present embodiment provides routines of mask data processing able to handle for example the above-mentioned beam stencil mask 1c. In more detail, the mask processing apparatus 1 prepares the device characteristic data of the used exposure apparatus 6 based on the design data prepared at the design processing device 2 and the complementary stencil mask data, in more detail the data for drawing the mask based on parameters describing information such as the mask characteristic data of the mask etc.

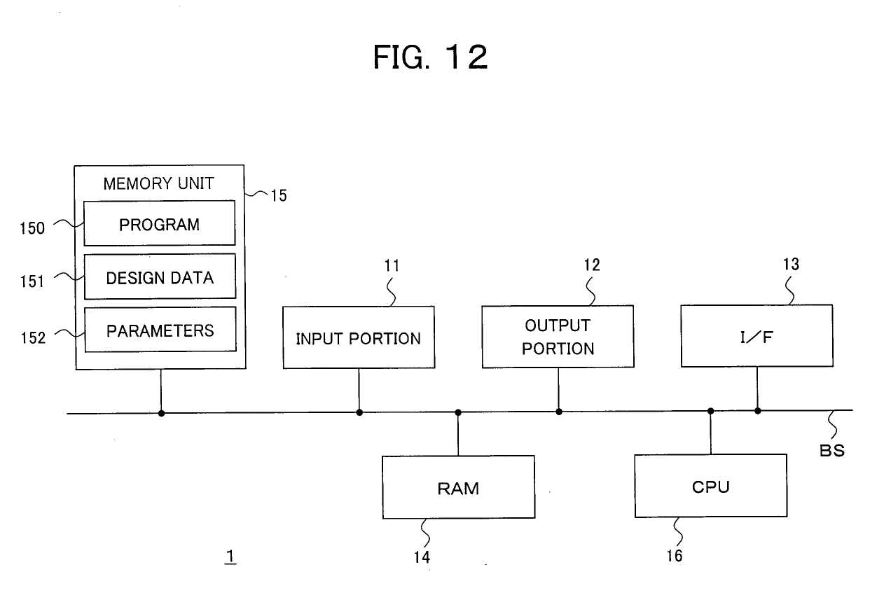

FIG. 12 is a hardware like block diagram of an embodiment of the mask processing apparatus according to the present invention.

The mask processing apparatus 1 has, for example as shown in FIG. 12, an input portion 11, output portion 12, interface (I/F) 13, RAM 14, memory unit 15, and CPU (central processing unit) 16.

The input portion 11, output portion 12, I/F 13, RAM 14, memory unit 15, and the CPU 16 are connected by a bus BS.

The input portion 11 outputs desired input data to the CPU 16. For example, the input portion 11 is a data input device such as a keyboard or mouse, CDROM (R, RW) drive, and floppy (registered trademark) disk drive (FD). For example, the input portion 11 may input design data, mask data etc. as the input data.

The output portion 12 performs the output in accordance with the predetermined output data output from the CPU 16. For example, the output portion 12 is a display device such as display and performs a display in accordance with the output data output from the CPU 16.

Through the interface (I/F) 13 desired data is transferred to the other information processing devices, for example, the design processing device 2, mask preparation processing device 3, and the exposure processing device 5 under the control of the CPU 16. As explained above, the I/F 13 may receive the design data output from the design processing device 2 as well.

The RAM 14 is used as a work space when performing for example predetermined processing by the CPU 16. The memory unit 15 is written with or read for the desired data by the CPU 16.

The memory unit 15 has for example a program 150, design data 151, parameters 152, etc.

The program 150 includes for example processing routines concerning the mask processing according to the present embodiment and executed by the CPU 16 by using the RAM 14 as the work space.

The design data 151 is the design data of for example the circuits formed on the wafer.

The parameters 152 include for example the device characteristic data of the mask preparation device 4, the device characteristic data of the exposure apparatus 6, and the mask characteristic data of the complementary stencil masks. For example, the parameters 152 include parameters indicating the type of processing of the exposure apparatus 6, mask information, for example, data indicating the material of the mask and mask process, and the map data (layout data) of the mask.

The CPU 16 performs for example processing based on the processing routines concerning the mask processing in accordance with the programs 150.

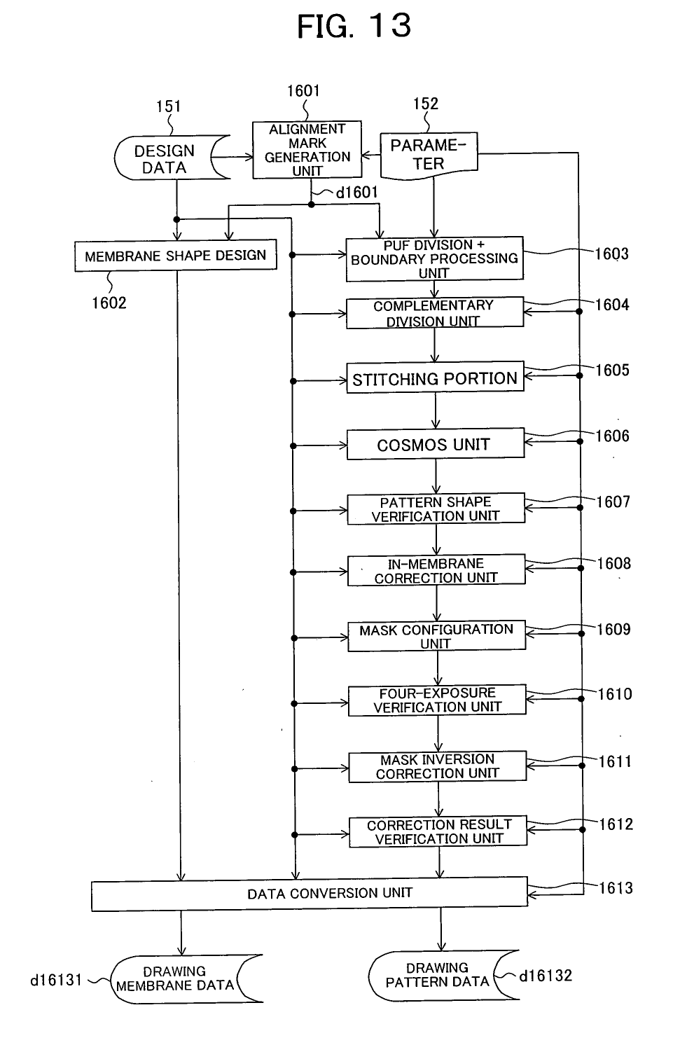

FIG. 13 is a diagram showing an embodiment of the software like functional block of the mask processing apparatus shown in FIG. 1.

The CPU 16 has, for example as shown in FIG. 13, an alignment mark generation unit 1601, membrane shape design portion 1602, PUF and boundary processing unit 1603, complementary division unit 1604, stitching portion 1605, COSMOS layout unit (COSMOS unit) 1606, pattern shape verification unit 1607, in-membrane correction unit 1608, mask configuration unit 1609, exposure verification unit 1610, mask inversion correction unit 1611, correction result verification unit 1612, and data conversion unit 1613.

The alignment mark generation unit 1601 generates alignment marks d1601 based on the design data 151 and the parameter 152. For example, in detail, the alignment mark generation unit 1601 generates mask alignment marks d16011 and wafer alignment marks d16012 based on the data design data 151 and the parameters 152.

The mask alignment marks d16011 are mask alignment marks d16011 for the mask, while the wafer alignment marks d16012 are wafer alignment marks patterned on the wafer for use in alignment of the step explained later.

FIG. 14 is a diagram for explaining the alignment marks.

For example, when multiply exposing a mask complementarily divided like in the LEEPL, it is necessary to position the mask c1 and the wafer wf3 with a high precision. For this reason, for example, the die alignment system is used for positioning by measuring the scattered light of irradiated white light.

In more detail, for example as shown in FIG. 14, the mask c1 is provided with a plurality of mask alignment marks d16011, for example, holes, while the wafer wf3 is provided with a plurality of wafer alignment marks d16012, for example, grooves.

White light lt4 is irradiated from an oblique direction, for example, obliquely at 40 degrees with respect to the plane of the mask c1 and the wafer wf3, relative positions of the mask c1 and the wafer wf3 are measured from peak positions of signals of the scattered light and reflected light 1t5 at the mask alignment marks d16011 provided in the mask c1 and the wafer alignment marks d16012 provided in the wafer wf3, deviations from desired positions are measured, and position correction processing is carried out for each exposure (shot) based on the measured deviation information.

At this time, based on the scattered light and the reflected light 1t5 at the mask alignment marks d16011 and the wafer alignment marks d16012, offset, rotation, magnification, etc. are measured for each shot, the gap between the mask c1 and the wafer wf3 is measured, and position correction processing is carried out based on the measurement results.

As explained above, the mask alignment marks d16011 and the wafer alignment marks d16012 are referred to when multiply exposing the wafer wf3 by using the mask c1 by the exposure apparatus 6, therefore the alignment mark generation unit 1601 designs the layout of the mask alignment marks d16011 and the wafer alignment marks d16012 based on the parameters 152 including the device characteristic data of the exposure apparatus 6 etc.

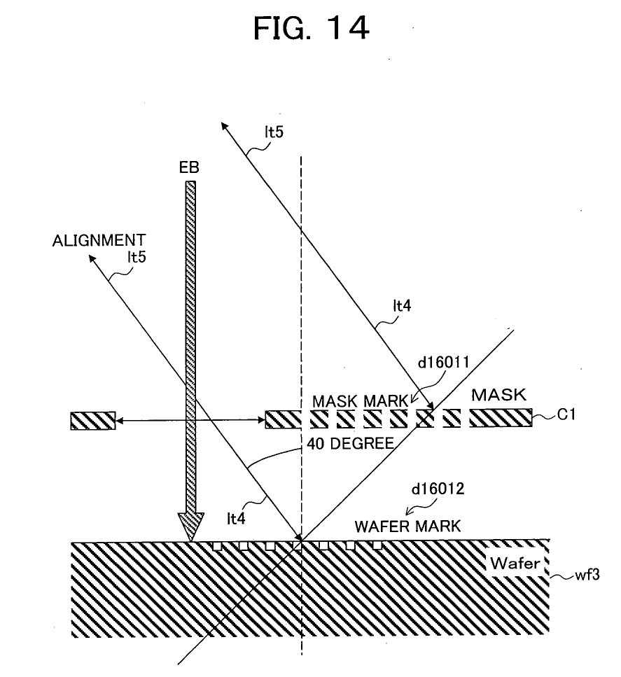

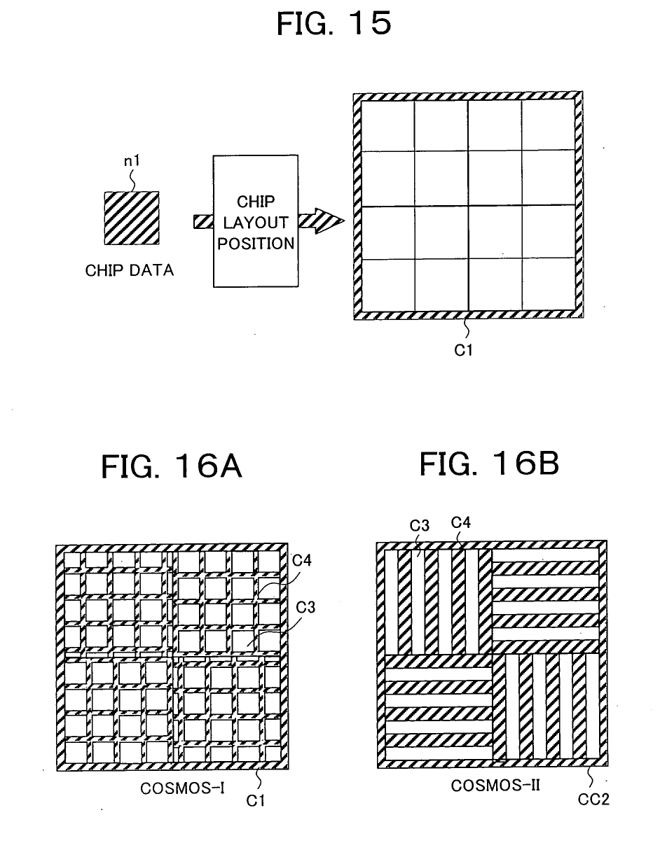

FIG. 15 is a diagram for explaining the relationship between the design data and the mask.

As schematically shown in FIG. 15, the region for preparing the membrane c3 is determined in the membrane data preparation processing explained later according to the design data (also referred to as layout information of the chip) n1 and the alignment marks d1601 etc., therefore the CPU 16 outputs parameters 152 including data such as the sizes of the chip and mask to the membrane shape design unit 1602 and the PUF division and boundary processing unit 1603.

The membrane shape design unit 1602 generates a predetermined membrane shape based on the design data 151, parameters 152, and the alignment marks d1601 output from the alignment mark generation unit 1601.

The membrane shape design unit 1602 designs the data concerning the membranes (COSMOS-I and II) based on the type of the complementary mask (for example COSMOS-I and II) included in the parameters 152 and information such as the chip size included in the design data 151 and outputs the data for generating the membrane to the data conversion unit 1613.

FIG. 16A and FIG. 16B are diagrams showing specific examples of the mask according to the present embodiment.

In more detail, the membrane shape design unit 1602 generates data for designing the membrane c3 in accordance with the COSMOS mask when arranging a square (1 cm □ having a chip size of 1 cm in the mask as shown in for example FIG. 16A. This data includes data concerning the first complementary stencil mask (COSMOS-I) c1, for example, the information such as a width 1 mm of the beams c4 and a width 4 mm of the membrane c3.

Further, the membrane shape design unit 1602 generates data for designing the membrane in accordance with the second complementary stencil mask as shown in FIG. 16B in the case of the second complementary stencil mask (COSMOS-II) cc2. For example, this data includes the information indicating for example that the widths of the beams c4 of the COSMOS-II c22 and the membrane c3 are 2.5 mm.

The widths of the beam c4 and the membrane c3 differ according to the material used for the stencil masks c1 and c22, mask process, etc. For this reason, the membrane shape design unit 1602 determines the widths etc. of the beams c4 and the membrane c3 based on the data concerning the material used for the stencil mask c1 included in the parameters 152, the mask process, etc.

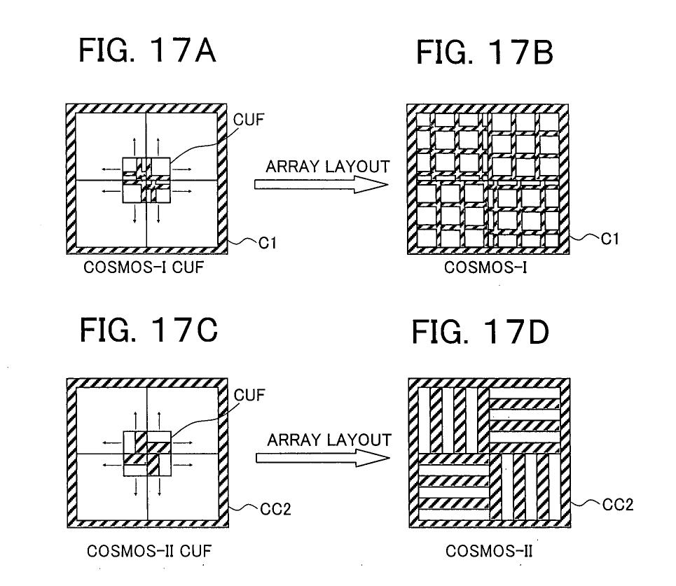

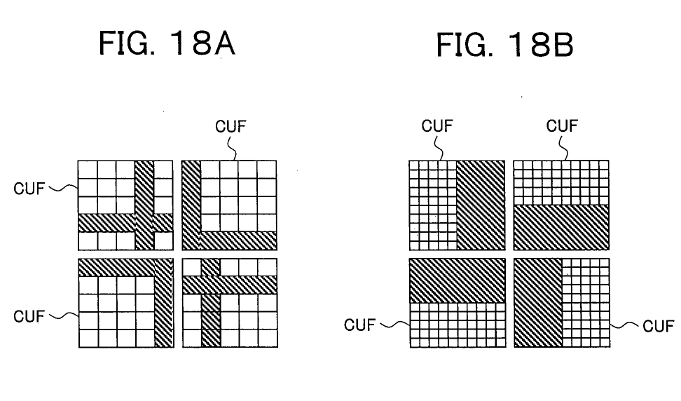

FIG. 17A to FIG. 17D are diagrams for explaining the unit field of a mask. FIG. 17A is a diagram for explaining the unit field of the first complementary mask, and FIG. 17B is a diagram for explaining the unit field of the second complementary mask. FIG. 18A is a diagram enlarging part of FIG. 17A, and FIG. 18B is a diagram enlarging part of FIG. 17C.

In the present embodiment, the width of the beams of the COSMOS-I shown in FIG. 18A is about 250 μm, and the width of the beams of the COSMOS-II shown in FIG. 18B is about 1 mm.

The PUF and boundary processing unit 1603 performs the PUF division processing and boundary processing based on the design data 151, the parameters 152, and the alignment marks d1601.

The complementary masks c1 and cc2 are constituted by arranging the COSMOS unit fields (CUF) in an array.

In the first complementary mask (COSMOS-I) c1, for example as shown in FIG. 17A and FIG. 17B, CUFs are arranged in an array in each of the four sections. Further, in the second complementary mask (COSMOS-II) c22, as shown in FIG. 17C and FIG. 17D, CUFs are arranged in an array in each of the four sections.

For example, in more detail, as shown in FIG. 18A, in order to form the mask of the first complementary mask c1, the region of a CUF is complementarily divided to 5 x 5 processing regions, and the results of the complementary division are allocated to four sections to prepare the complementary mask data. Further, as shown in FIG. 18B, in order to form the mask of the second complementary mask cc2, the region of a CUF is complementarily divided to 10×10 processing regions, and the complementarily divided results are allocated to four sections to generate the complementary mask data.

However, in the first and second complementary masks, the mask shapes differ as shown in FIG. 17A and FIG. 17B, therefore the minimum processing regions for preparing the mask differ.

The PUF and boundary processing unit 1603 performs the layout of the mask after the complementary division processing based on a map in accordance with the mask shape after the-end of the complementary division in the present embodiment, therefore divides the processing unit at this time to processing unit fields (hereinafter referred to as PUFs) having a size matching with any of the plurality of mask shapes and performs the complementary division processing for each PUF. Due to this, the processing of complex complementary masks can be accomplished with a simple complementary division function.

For example, in the present embodiment, the PUF is a region obtained by dividing the CUF of COSMOS-II shown in FIG. 18B to 10×10 regions.

The PUF and boundary processing unit 1603 divides the input design data (chip data) 151 to PUF sizes in order to perform the processing by a PUF. Further, the PUF and boundary processing unit 1603 performs the boundary processing for performing this PUF division.

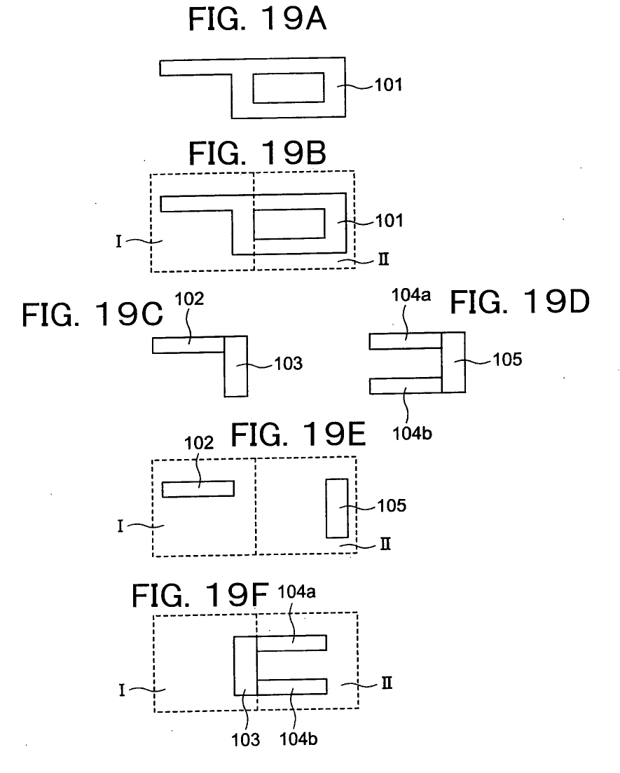

FIG. 19A to FIG. 19F are diagrams for explaining the boundary processing.

The boundary processing simply performs the complementary division processing for each PUF for the predetermined pattern. When combining the results of the complementary division processing, sometimes a disadvantageous pattern may occur in the stencil mask at adjoining PUF boundaries, therefore the processing is performed so as not to generate such the disadvantageous pattern.

The disadvantageous pattern will be explained.

For example, the PUF and boundary processing unit 1603 divides the pattern 101 as shown in FIG. 19A to the PUF I and PUF II as shown in FIG. 19B. Then, the PUF and boundary processing unit 1603 performs the complementary division for each PUF. For example, as shown in FIG. 19C, the PUFI is divided to a pattern 102 and a pattern 103, and the PUF II is divided to patterns 104a, 104b, and 105 as shown in FIG. 19D.

For example, the complementary mask A is allocated the divided pattern 102 of the PUF I and the divided pattern 105 of PUF II as shown in FIG. 19E, and PUF I and PUF II are stitched with each other.

To complementary mask B is allocated the divided pattern 103 of PUF I and the patterns 104a and 104b of PUF II as shown in FIG. 19F, and PUF I and PUF II are stitched with each other. At this time, in the case when for example the pattern as shown in FIG. 19F is formed in the stencil mask, a disadvantageous pattern having a leaf shape is formed.

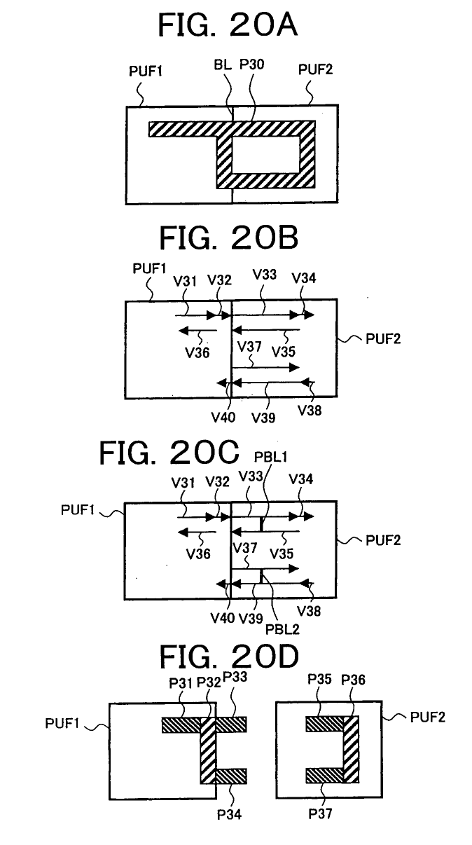

FIG. 20A to FIG. 20D are diagrams for explaining the boundary processing.

In order to prevent the above disadvantageous pattern, the PUF and boundary processing unit 1603 extracts the side in a predetermined direction, for example, a direction along the vertical direction with respect to a PUF boundary BL, before complementarily dividing for example the pattern on the PUF boundary for each PUF, generates a vector in accordance with the extracted side, divides the pattern on the PUF boundary BL when the length of a pair of facing vectors having the same length is a predetermined length or more, and performs the complementary division for each PUF based on the divided pattern.

The PUF and boundary processing unit 1603 performs the pattern division processing for a pattern P30 when the pattern P30 exists on the boundary line BL of the PUF1 and PUF2 as shown in for example FIG. 20A.

The PUF and boundary processing unit 1603 performs the vectorization processing in accordance with the side of the pattern P30 along the direction vertical to the boundary line BL based on the pattern P30 on the PUF1 as shown in for example FIG. 20A to generate vectors V31 to V40.

At this time, the PUF and boundary processing unit 1603 performs processing such as decomposition of a vector so as to form a pair of vectors having the same length.

As shown in FIG. 20C, the PUF and boundary processing unit 1603 starts for example the movement of a boundary division judgment line BDL parallel to the boundary line BL from the position of the boundary line BL parallel to the boundary line BL based on vectors V31 to V40 shown in FIG. 20B and generates the division line PBL based on the predetermined division condition, for example, a condition that the division be carried out in the case where the length is a predetermined length or more with respect to a pair of vectors crossing this boundary division judgment line BDL. For example, in the case of the vector shown in FIG. 20B, the PUF and boundary processing unit 1603 generates division lines PBL1 and PBL2 as shown in FIG. 20C.

The PUF and boundary processing unit 1603 divides the pattern P30 to patterns P31 to P37 as schematically shown in for example FIG. 20D based on division lines P11 and PL2.

The PUF and boundary processing unit 1603 performs the pattern division processing with respect to a pattern on the PUF before the complementary division unit 1604 performs the complementary division processing as explained above, then the complementary division unit 1604 performs the complementary division processing for the pattern division processed pattern for each PUF unit, so it is possible to prevent the generation of a problem pattern.

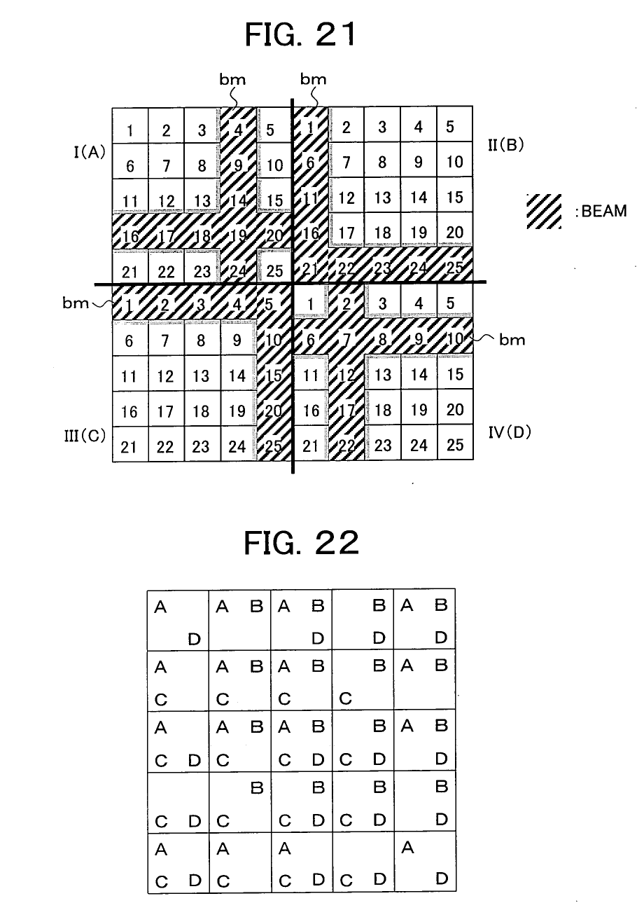

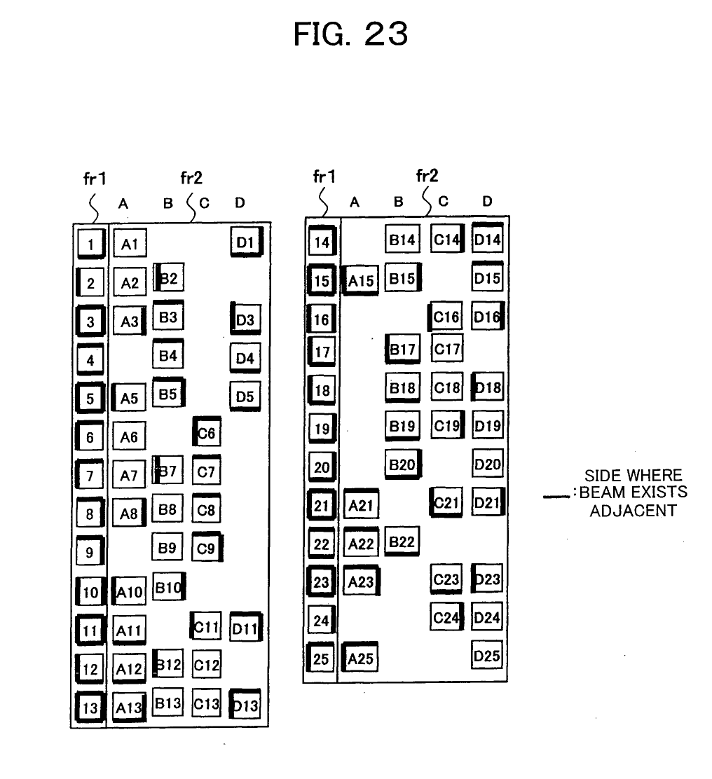

FIG. 21 is a diagram extracting the smallest patterns to be multiply exposed among sections of the stencil mask shown in FIG. 8. FIG. 22 is a diagram for explaining sections in which individual PUFs (blocks) in the smallest patterns shown in FIG. 21 can be arranged. FIG. 23 is a diagram for explaining the section in which the position information of the beams of the patterns shown in FIG. 22 can be arranged.

The smallest patterns to be multiply exposed in the first complementary mask c1 are formed in each of sections I(A), II(B), III(C), and IV(D) as shown in for example FIG. 21. As shown in FIG. 21, in each of sections I to IV, beams bm are formed at predetermined positions.

The patterns formed in each of the 5×5 PUFs (blocks) of each section can be formed in each of the corresponding sections I(A) to IV(D) as shown in FIG. 22.

The COSMOS layout unit 1606 performs the layout by considering the positions of the beams bm adjacent to the PUFs as shown in FIG. 23 when also considering the positions of the beams bm adjacent to the PUFs when arranging the patterns for each PUF in each section.

For example, in more detail, as shown in FIG. 23, each PUF has at least one side and vertex not overlapping the beam bm. Specifically, as shown in FIG. 23, in the PUF1, there is a possibility that two sides overlap the beam bm in the D region, but in the A region, there is no possibility that four sides overlap beams bm. In FIG. 23, a side adjacent to the beam bm is expressed by a bold line.

In the PUF1, the region A1 does not overlap the beams bm at the four sides. The PUF is located at the position of the beams in the regions B and C, so patterns cannot be laid there. In the PUF, the region D overlaps the beams bm at the right side and the bottom side of the drawing. In the PUF2, the region A2 does not overlap the beams bm.

A region 1 corresponds to a region A1 and a region D1. The right side and the bottom side of the region D1 overlap beams bm. A region 2 corresponds to a region A2 and a region B2. The left side of the region B2 overlaps the beam bm. A region 3 corresponds to a region A3, a region B3, and a region D3. The right side of the region A3, the top side of the region B3, and the left side and the bottom side of the region D3 overlap the beams bm. A region 4 corresponds to a region B3 and a region D4. The top side of the region B4 and the bottom side of the region D4 overlap the beams bm. A region 5 corresponds to a region A5, a region B5, and a region D5. The left side of the region A5, the top side and right side of the region B5, and the bottom side of the region D5 overlap the beams bm.

A region 6 corresponds to a region A6 and a region C6. The top side and the left side of the region C6 overlap the beams bm. A region 7 corresponds to a region A7, a region B7, and a region C7. The left side of the region B7 and the top side of the region C7 overlap the beams bm. A region 8 corresponds to a region A8, a region B8, and a region C8. The right side of the region A8 and the top side of the region C8 overlap the beams bm. A region 9 corresponds to a region B9 and a region C9. The beams bm overlap the top side and right side of the region C9. A region 10 corresponds to a region A10 and a region B10. The beams bm overlap the left side of the region A10 and the right side of the region B10.

A region 11 corresponds to a region A11, a region C11, and a region D11. The beams bm overlap the bottom side of the region 11, the left side of the region C11, and the top side and right side of the region D11. A region 12 corresponds to a region A12, a region B12, and a region C12. The beams bm overlap the bottom side of the region A12 and the left side of the region B12. A region 13 corresponds to a region A13, a region B13, a region C13, and a region D13. The beams bm overlap the bottom side and right side of the region A13 and the top side and left side of the region D13. A region 14 corresponds to a region B14, a region C14, and a region D14. The beams bm overlap the right side of the region C14 and the top side of the region D14. A region 15 corresponds to a region A15, a region B15, and a region D15. The beams bm overlap the left side and the bottom side of the region A15, the right side of the region B15, and the top side of the region D15.

A region 16 corresponds to a region C16 and a region D16. The beams bm overlap the left side of the region C16 and the right side of the region D16. A region 17 corresponds to a region B17 and a region C17. The beams bm overlap the left side and bottom side of the region B17. A region 18 corresponds to a region B18, a region C18, and a region D18. The beams bm overlap the bottom side of the region B18 and the left side of the region D18. The region 19 corresponds to a region B19, a region C19, and a region D19. The beams bm overlap the bottom side of the region B19 and the right side of the region C19. A region 20 corresponds to a region B20 and a region D20. The beams bm overlap the right side and bottom side of the region B20.

A region 21 corresponds to a region A21, a region C21, and a region D21. The beams bm overlap the top side of the region A21, the left side and bottom side of the region C21, and the right side of the region D21. A region 22 corresponds to a region A22 and a region B22. The beams bm overlap the top side of the region A22 and the bottom side of the region B22. A region 23 corresponds to a region A23, a region C23, and a region D23. The beams bm overlap the top side and right side of the region A23, the bottom side of the region C23, and the right side of the region D23. A region 24 corresponds to a region C24 and a region D24. The beam bm overlaps the right side of the region C24. A region 25 corresponds to a region A25 and a region D25. The beam bm overlaps the top side of the region A25.

As the complementary patterns complementarily divided by the PUF and boundary processing unit 1603, the COSMOS layout unit 1606 arranges the above-explained patterns P31 to P37 in the regions I to IV based on the predetermined layout data.

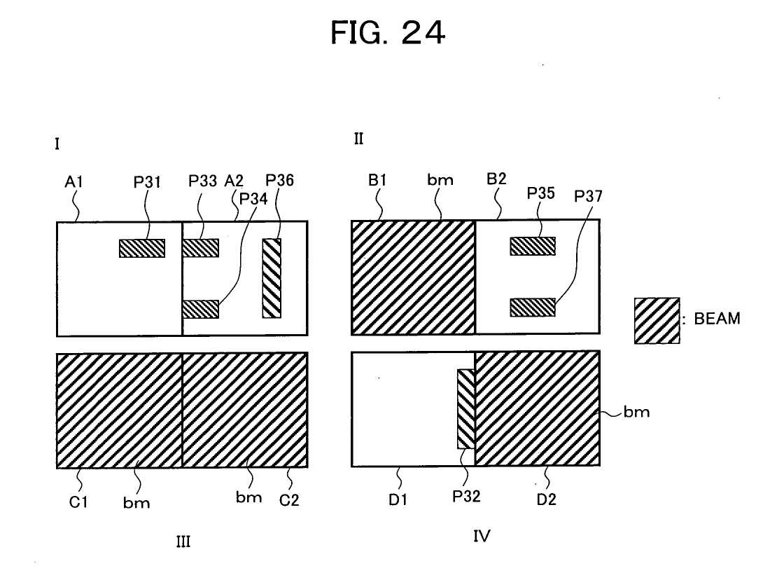

FIG. 24 is a diagram showing a specific example of the layout. In more detail, as shown in FIG. 24, the pattern P31 is arranged in the region A1, the patterns P33, P34, and P36 are arranged in the region A2, the patterns P35 and P37 are arranged in the region B2, and the pattern P32 is arranged in the region D1.

At this time, the COSMOS layout unit 1606 selects regions not overlapping the beams bm (at least A, B, C, or D) based on the layout data shown in FIGS. 21 to FIG. 23 for patterns crossing the boundary lines BL after the complementary division for each PUF and thereby can prevent the division of the patterns by halves by the beams bm.

For example, when there are patterns crossing the PUF boundaries on the top side and the left side after the complementary division in a PUF of the region 25, if the patterns are arranged in the region A25, they will overlap the beams bm, but if the patterns are arranged in the region D25, they will not overlap the beams bm.

In this way, the COSMOS layout unit 1606 can perform the layout without forcibly dividing patterns by the beams bm when processing PUF1 to PUF25 to arrange the complementarily divided patterns.

In the present embodiment, even when patterns after the complementary division contact each other (except point contact) at the time of PUF division, the patterns are divided at positions where complementary contradictions do not occur.

Further, for example, this boundary processing may be included in the complementary division processing as well. In this case, since the complementary division is carried out in the PUF and processing is carried out at a boundary portion by considering the other fields, the algorithm becomes very complex, so inevitably become a cause of lower reliability.

The PUF and boundary processing unit 1603 according to the present embodiment performs the boundary processing when performing the PUF division, so can easily acquire also graphic information of the neighboring fields. This boundary processing overcomes also the fine graphic disadvantage which may occur on the PUF boundary.

The complementary division unit 1604 performs the complementary division processing based on the patterns as explained above. For details of the complementary division, some known techniques such as Japanese Patent No. 3105580, Japanese Examined Patent Publication (Kokoku) No. 7-66182, Japanese Unexamined Patent Publication (Kokai) No. 11-354422, Japanese Unexamined Patent Publication (Kokai) No. 2000-91191, Japanese Unexamined Patent Publication (Kokai) No. 2001-244192, Japanese Unexamined Patent Publication (Kokai) No. 2001-274072, Japanese Unexamined Patent Publication (Kokai) No. 2002-99075, Yamashita et al. 48th Applied Physics Joint Conference Preprints 30a-ZE-5, Yamashita et al. 61st Applied Physics Joint Conference Preprints 7a-X-8, etc. can be selected.

For example, the complementary division processing now known art is complementary division into two in many cases. For example, two-complementary division can be processed without a problem by the second complementary mask. (COSMOS-II) cc2.

However, for the first complementary mask (COSMOS-I) c1, there is a portion which can be complementarily divided into two or four according to PUF like the layout data of FIGS. 22 and 23. In the case of a stencil mask, there is a possibility that pattern distortion will occur due to extent of the area where holes are formed in the membrane, therefore it is necessary to reduce the difference of the pattern area by assigning patterns to all PUFs which can be complementarily divided to three and complementarily divided to four.

The complementary division unit 1604 basically performs the processing so as to assign the patterns to 3 complementarily divided patterns or more when assigning the 2 complementarily divided patterns.

Sometimes the stitching precision of the complementarily divided patterns suffers from the disadvantage when performing multiple exposure using the complementarily divided patterns to form the desired patterns. For this reason, the stitching portion 1605 adds predetermined patterns or extends patterns to the divided portions when the complementary division unit 1604 performs the complementary division processing.

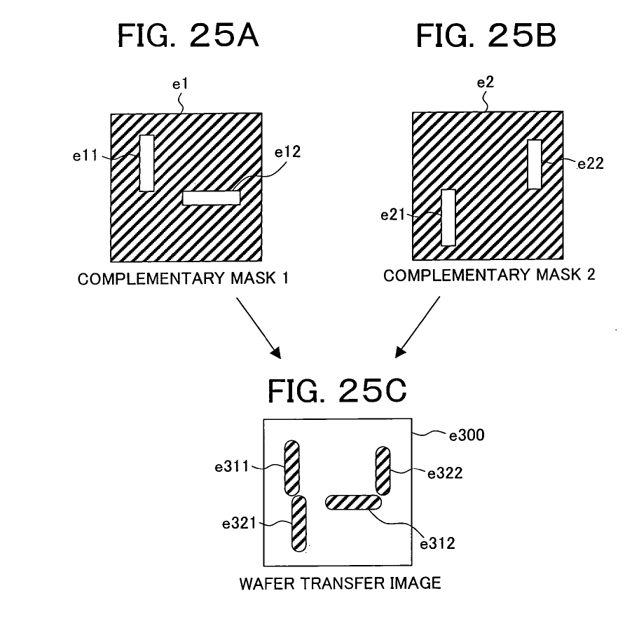

FIG. 25A to FIG. 25C are diagrams for explaining the stitching precision at the time of multiple exposure.

In more detail, when multiply exposing a wafer by using for example a complementary mask e1 including complementary patterns e11 and e12 shown in FIG. 25A and a complementary mask e2 including complementary patterns e21 and e22 shown in FIG. 25B, a transfer pattern e300 as shown in for example FIG. 25C is formed. In the transfer pattern e300, patterns e311, e312, e321, and e322 are formed, but at the time of multiple exposure using for example an electron beam, rounding of the corners of the patterns and deviation in alignment of the complementary masks e1 and e2 occur, therefore sometimes the pattern e311 and the pattern e321 are disconnected and sometimes the pattern e322 and the pattern e312 are disconnected.

As a method for preventing this disconnection, as disclosed in for example Japanese Patent No. 270699 and Japanese Patent No. 2730687, the method of adding predetermined patterns or extending patterns to divided parts when complementary dividing patterns is known.

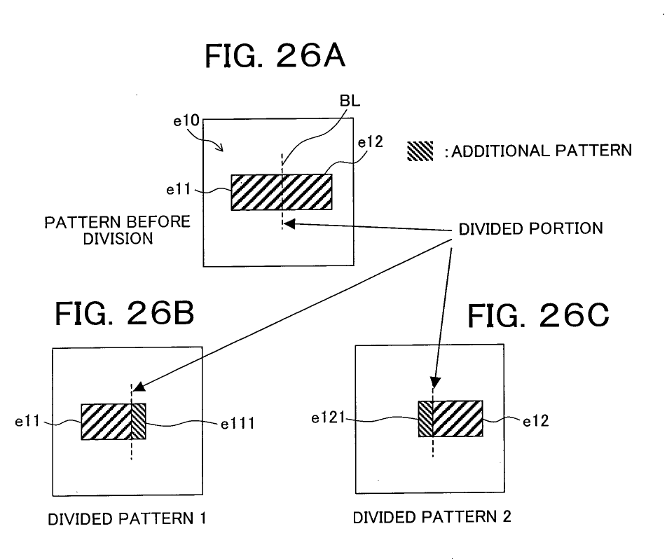

FIG. 26A to FIG. 26C are diagrams for explaining the stitching.

In more detail, the stitching portion 1605 adds predetermined patterns e111 and e121 so as to repair a divided part of the division line BL when the complementary division unit 1604 performs complementary division on the pattern e10 as shown in for example FIG. 26A based on the division line BL and as a result generates the pattern e11 in the complementary mask e21 as shown in FIG. 26B and the pattern e12 in the complementary mask e22 as shown in FIG. 26C.

When using a high energy exposure apparatus in a later step, if simply adding predetermined patterns, the patterns may become enlarged. Therefore, the stitching portion 1605 adds patterns smaller than the predetermined patterns in order to suppress pattern enlargement. At this time, the technology disclosed in for example Japanese Unexamined Patent Publication (Kokai) No. 64-269532 is used. Further, when using a low energy exposure apparatus for exposure in a later step, there is almost no enlargement of the patterns, so the stitching portion 1605 adds fine patterns for correction.

The stitching portion 1605 performs the above pattern addition for the disconnected portions at the time of PUF division and the disconnected portions at the time of complementary division as explained above.

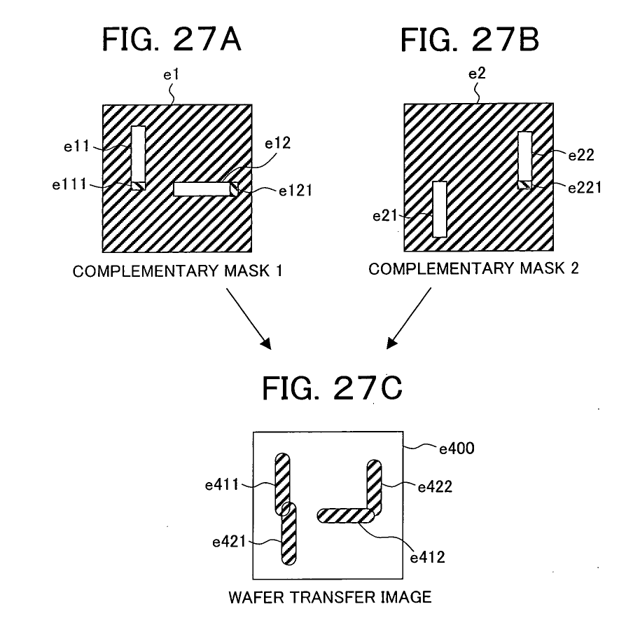

FIG. 27A to FIG. 27C are diagrams for explaining the operation of stitching.

The stitching portion 1605 adds patterns e111, e121, and e221 so as to prevent disconnection when the complementary division results in division to the complementary mask e1 having the complementary patterns e11 and e12 shown in FIG. 27A and the complementary mask e2 having the complementary patterns e21 and e22 as shown in FIG. 27B. When using the resultant complementary masks e1 and e2 for multiple exposure, a transfer pattern e400 in which patterns e411 and e421 are connected and a pattern e412 is connected can be formed as shown in for example FIG. 27C.

The COSMOS layout unit 1606 performs the layout of pattern data complementarily divided by the PUF and complementary division unit 1604 and the stitching portion 1605 in each section of the stencil mask based on the map data (layout data) in accordance with the mask shape included in the parameters 152.

The COSMOS layout unit 1606 arranges the complementarily divided patterns in predetermined sections of the stencil mask having the predetermined shapes based on the layout data indicating how the data of PUFs arranged in the memory portion 15 shown in for example FIGS. 22 and 23 are assigned. At this time, the COSMOS layout unit 1606 performs the layout of the complementary patterns based on the data concerning the two-complementary, three-complementary, and four-complementary division and the data concerning the beam positions of the adjacent blocks, etc.

Further, the COSMOS layout unit 1606 of the present embodiment performs the layout based on a map corresponding to the mask shape even in the case of another mask shape, therefore another mask shape can be easily handled without changing the main flow of layout processing in comparison with the case where processing is carried out according to a flow of layout processing dedicated to for example a predetermined mask shape.

The PUFs are arranged in the membranes and combined by the COSMOS layout unit 1606. As a result, there is a possibility that adjacent PUFs may be formed with donut shape or leaf pattern patterns or defect patterns which cannot be formed on the stencil mask due to trouble with the complementary division function.

The pattern shape verification unit 1607 verifies whether or not the complementary patterns for each membrane arranged by the COSMOS layout unit 205 can be formed on the membrane.

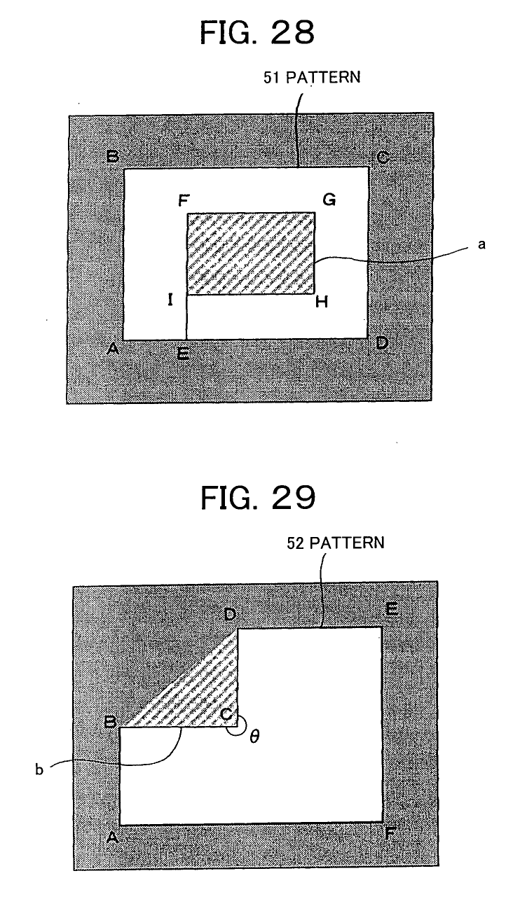

FIG. 28 is a diagram for explaining the processing of the pattern shape verification unit for detection of a donut pattern.

The pattern shape verification unit 1607 detects a defect pattern, for example, a donut pattern, as shown in FIG. 28 as follows.

The pattern shape verification unit 1607 defines a pattern having two or more vertexes traced two or more times when for example drawing a pattern with one stroke as a “defect pattern”.

In more detail, as shown in FIG. 28, when drawing a pattern 51 with one stroke using a vertex A as the start point and end point, the vertexes are traced as follows. After sequentially tracing the vertex A, vertex B, . . . , and vertex E, a side is added to the inner circumference of the pattern 51 and a vertex F is traced. Further, after sequentially tracing the vertex G, vertex H, and vertex I, the vertex E on the outer circumference of the pattern 51 is returned to again. The tracing ends at the vertex A. At this time, the number of vertexes which are traced a plurality of times are the three vertexes of the vertex A traced two times, the vertex E traced two times, and further the vertex I traced two times (note, passed through once).

As described above, when finishing drawing one pattern, if there are two or more vertexes counted as vertexes traced two or more times when drawing the pattern by one stroke, the pattern shape verification unit 1607 detects this pattern as a defect pattern.

That is, when a pattern of the above donut shape, if drawing this with one stroke, a side drawn by connecting an island portion a at the center of the donut shape and a portion surrounding its periphery (vertex E-vertex I) is generated. The vertexes formed at the two ends of this side will be traced two times each.

FIG. 29 to FIG. 31 are diagrams for explaining the processing of the pattern shape verification unit for detection of leaf patterns.

The pattern shape verification unit 1607 detects for example leaf patterns as shown in FIGS. 29 to 31 as follows.

The pattern shape verification unit 1607 judges a pattern having a vertex with a value of (inner angle—180°) of a predetermined value or more and a pattern with vertexes having inner angles exceeding 180° continuously provided and with a sum of (inner angle-180°) at these continuous vertexes of a predetermined value or more as defect patterns.

In more detail, for example for a pattern 52 as shown in FIG. 29, the inner angles θ of the vertexes are detected in the sequence of the vertex A, vertex B, . . . , and vertex F. At this time, based on the detected inner angles, when the pattern has a vertex with a value of (inner angle θ-180°) of a predetermined value θs or more, that exposure pattern is extracted as a defect pattern. For example, the predetermined value θs is set at 90°.

By this, for example in the exposure pattern 52 shown in FIG. 29, when the inner angle θ of the vertex C forming the leaf state region b is 270°, the (inner angle θ-180°) of this vertex C is 90° and the pattern meets the condition that the predetermined value θs=90° or more, so the pattern shape verification unit 1607 detects this pattern as a defect pattern.

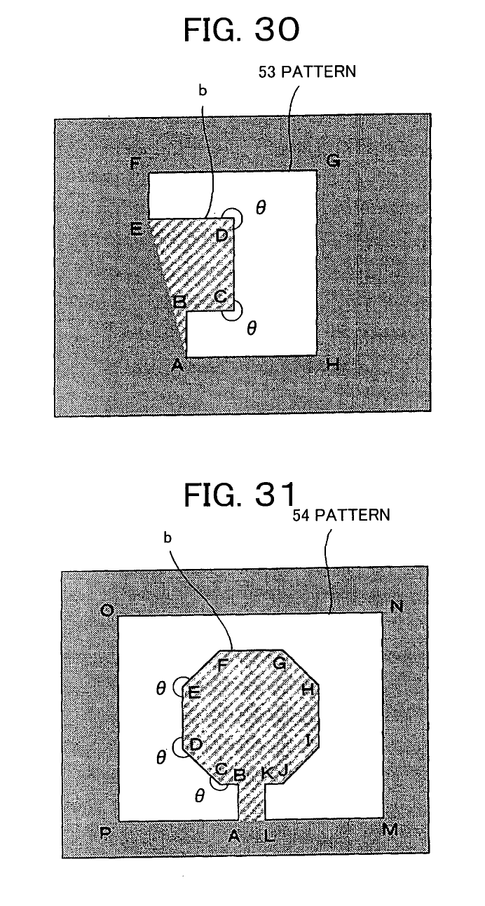

In the same way, in for example the pattern as shown in FIG. 30, when the inner angle θ of the vertex D forming the leaf state region b is 270°, if detecting the inner angles in the sequence of the vertex A, vertex B, . . . , and vertex H, the (inner angle θ-180°) becomes 90° at the vertex C and the vertex D, so the pattern shape verification unit 1607 detects this pattern as a defect pattern.

Further, the unit simultaneously extracts defect patterns as follows based on the inner angles of the patterns.

First, when sequentially detecting the inner angles θ along the pattern and a detected inner angle θ exceeds 180°, the unit calculates the value of (inner angle θ-180°) at that vertex. Then, when the inner angle of the continuously arranged next vertex exceeds 180°, it calculates the value of (inner angle θ-180°) at this vertex and adds it to the value of (inner angle θ-180°) at the previous vertex. On the other hand, when the inner angle θ of the next vertex does not exceeds 180°, it cancels this cumulative value and returns it to 0. Then, it extracts patterns with a cumulative value of a predetermined value θss or more as defect patterns. Here, the predetermined value θss is set at for example 90°.

For example, in the pattern 53 shown in FIG. 30, when the inner angles θ of the vertex C and the vertex D forming the leaf shape region b are 270°, if sequentially detecting the inner angles θ from the vertex A, since the inner angle of the vertex C is 180° or more, the unit calculates (inner angle θ-180°)=90° for this vertex C. Then, since the inner angle θ of the vertex D is also 180° or more, it calculates the (inner angle θ-180°)=90° for this vertex D and adds this to the value of (inner angle θ-180°) at the previous vertex C. The cumulative result 90°+90°=180°≧predetermined value (90°), therefore the unit detects this pattern as a defect pattern.

In the same way, in the pattern 54 shown in FIG. 31, when the inner angles θ of the vertex C to the vertex J in the pattern 54 surrounding the leaf state region b are 225°, if sequentially detecting the inner angles θ from the vertex A, first, at the vertex C, (inner angle θ-180°) becomes equal to 45°, and at the vertex D continuously adjoining this, (inner angle θ-180°) becomes equal to 45°, so the unit adds these. The result is that 45°+45°=90°≧predetermined value θss (90°), therefore the unit detects this pattern 54 as a defect pattern.

Note that even when the predetermined value θss is set at for example θss=100°, (inner angle θ-180°)=45° at the next vertex E is added and 45°+45°=135°≧predetermined value θss (100°) results, therefore the unit detects this pattern as a defect pattern.

Further, by adjusting the settings of θs and θss, the degree of projection of the leaf state region b detected by the pattern shape verification unit 1607 can be adjusted.

Further, the pattern shape verification unit 1607 detects a pattern having for example a shape longer than a predetermined length as a defect pattern. This is because a pattern having a long shape is apt to cause distortion in the center region in the longitudinal direction when forming the pattern in a stencil mask as a real pattern.

The defect patterns detected by the pattern shape verification unit 1607 explained above are subjected to for example complementary division again by the complementary division unit 1604.

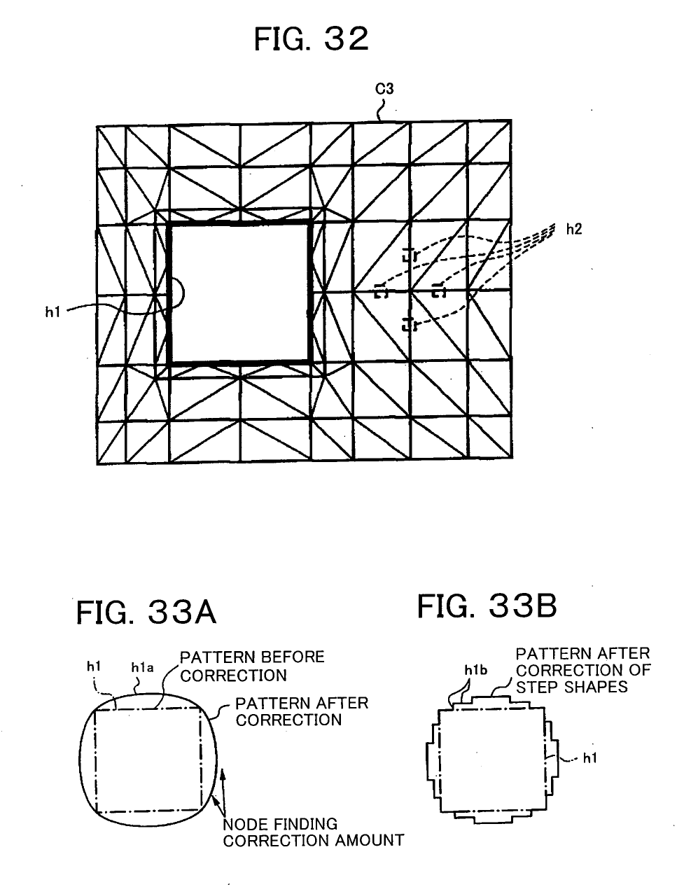

FIG. 32 is a diagram for explaining the distortion due to a hole formed in a stencil mask.

For example, as schematically shown in FIG. 32, where a hole h1 in accordance with the pattern is formed in the membrane c3, pattern displacement occurs in accordance with the hole. This is because a constant internal stress acts in the membrane c3, and the internal stress changes by forming the hole h1 in the membrane c3. There is no method for preventing this pattern displacement.

The in-membrane correction unit 1608 calculates a displacement amount occurring when forming the hole h1 in accordance with the complementary patterns verified by the pattern shape verification unit 1607 in the membrane c3 in accordance with the design data 151 and the parameters 152 and performs correction processing for the complementary stencil mask data so as to obtain the desired pattern as a result of the displacement in accordance with the calculation result.

In more detail, since the membrane c3 is fixed by the beams c4 and there is only a slight influence of the patterns in the membrane c3 upon the beams c4, the in-membrane correction unit 1608 regards the beams c4 as rigid bodies and conducts the analysis in units of the membrane c3. The membrane c3 is formed with the hole h1 in accordance with the complementary pattern s, therefore the in-membrane correction unit 1608 analyzes the displacement for each membrane.

The in-membrane correction unit 1608 performs the displacement analysis in the membrane by for example the finite element method or the differential method. At this time, since there are very many holes (patterns) h1 in the membrane, a long analysis time is taken. The in-membrane correction unit 1608 of the present embodiment analyzes the displacement in the membrane by displacement high speed analysis. The displacement high speed analysis processing calculates for example the displacement amount of only the holes formed in the membrane having a size more than a predetermined size and corrects the positions and shapes of the holes to the desired ones based on the results of the calculation.

The in-membrane correction unit 1608 divides an object for analysis into simple elements as shown in for example FIG. 32 in order to analyze the stress of the shape of the object when performing plane stress analysis by for example the finite element method. At this time, it divides the mask surface other than the holes in accordance with the complementary patterns to a set of for example triangular simple elements. As the elements of the division, it is also possible to divide the surface to square elements or complex elements giving analysis nodes to each element side other than triangular elements. In the case of triangular elements, the in-membrane correction unit 1608 finds the displacement amount according to the stress analysis at each vertex of the triangle for each element.

For example, the hole h1 shown in FIG. 32 is a square of 10 μm sides, while holes h2 are squares having 100 nm sides.

In the stress analysis according to the finite element method, one element is divided to finer elements in a portion where a large change in stress (easy concentration of stress) is expected or a portion where precise analysis is desirably carried out, for example, in FIG. 32, in the peripheral portion of the hole h1 having a larger size than the predetermined size.

At this time, the peripheral portion of the hole h2 having a smaller size than the predetermined size is divided to usual elements. This is because the desired pattern is exposed even when holes h2 of less than the predetermined size are not corrected much since it is deemed that the amount of change of shape is within a permissible range. By doing this, the finite element method can be executed at a high speed.

Further, the predetermined size is determined by the relationship between the dimensional precision permitted to the stencil mask used for the semiconductor device and the degree of change of the pattern with respect to the stress found according to the material and thickness of the stencil mask.

FIG. 33A is a diagram showing a hole (pattern) having a curved contour as a result of the correction processing according to the results of stress analysis. FIG. 33B is a diagram showing a pattern obtained by correction of step shapes as a result of the correction processing.

The in-membrane correction unit 1608 calculates the above displacement amount and generates a correction amount based on the calculation result. This correction amount is a value indicating to what degree each node is to be corrected independently. When the correction is carried out by using this value as it is, the hole h1 becomes a curve having a contour of for example the curved shape as shown in FIG. 33A. The generation of a large amount of patterns including such curves will increase the load on the mask data processing and mask preparation process.

For this reason, the in-membrane correction unit 1608 finds the precision permitted in the correction processing from the permitted precision on the mask preparation, finds a correction use permissible pitch using that value as the standard, corrects the hole h1 to the step shapes as shown in for example FIG. 33B for the portion which becomes the curve with the permissible pitch, and solves the curve to thereby generate a hole h1b comprised of only vertical and horizontal lines.

By performing this, the excess load due to curves is reduced both for the data processing and for the mask preparation.

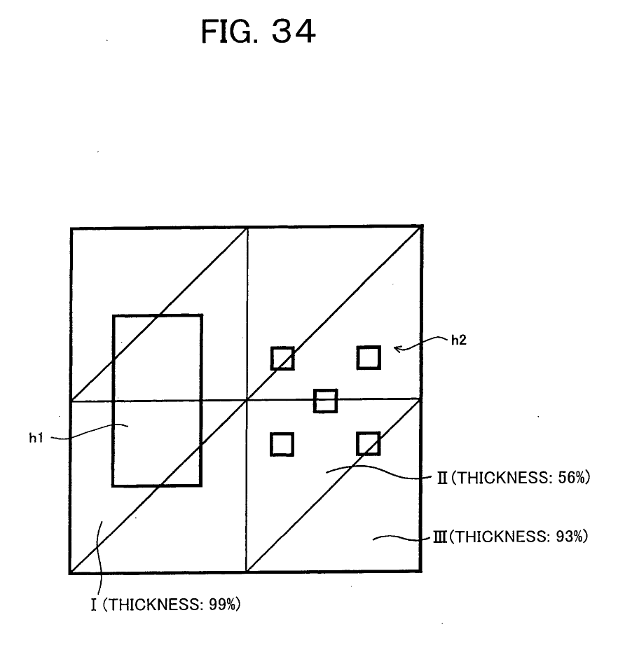

FIG. 34 is a diagram showing a specific example of the correction processing of the in-membrane correction unit.

Further, the in-membrane correction unit 1608 calculates an opening pattern area density (opening area density) based on the area of the hole patterns in the membrane and sets the thickness of a virtual membrane in accordance with the pattern area density.

For example, in more detail, as shown in FIG. 34, the unit sets the membrane to be virtually thinner than the predetermined thickness the larger the element in pattern area density. In the present embodiment, for example the peripheral portion of the hole (pattern) h1 has a pattern area density of 56% of the predetermined thickness, the peripheral portion of a hole (pattern) h2 has a pattern area density of 93% of the predetermined thickness, and the other peripheral portion not having holes (patterns) has a pattern area density of 99% of the predetermined thickness.

Then, the unit approximates the elastic matrix of each element including a hole (pattern) and having a predetermined thickness by a pseudo elastic matrix of each element not including a hole and having a virtual thickness, analyzes it by the finite element method, and corrects the shape and position of the hole (pattern) in accordance with the results. Here, an elastic matrix is an amount indicating the relationship between the stress and the distortion, while a pseudo elastic matrix is an elastic matrix when giving a virtual thickness in accordance with the pattern area density not including a hole (pattern).

The mask configuration unit 1609 performs one chip's worth of correction in the membrane based on the data corrected by the in-membrane correction unit 1608 and the parameters 152 and lays out the corrected chip in accordance with the mask constitution. For the displacement in the membrane, the same result is obtained at all positions on the mask so far as the patterns in the membrane are the same. At this time, in order to form the COSMOS mask as a whole, alignment patterns and other peripheral patterns are also provided.

The exposure verification unit 1610 performs processing for verification of layout mistakes or if the intended design data is obtained when the constituted COSMOS mask is exposed four times based on the mask constitution generated by the mask configuration unit 1609.

In more detail, the exposure verification unit 1610 performs a graphic processing AND on the obtained four-complementary data as the verification method and verifies if the layout of the original design data 151 and the data of the arrangement of the beam data coincide. By performing this verification, the exposure precision can be guaranteed.

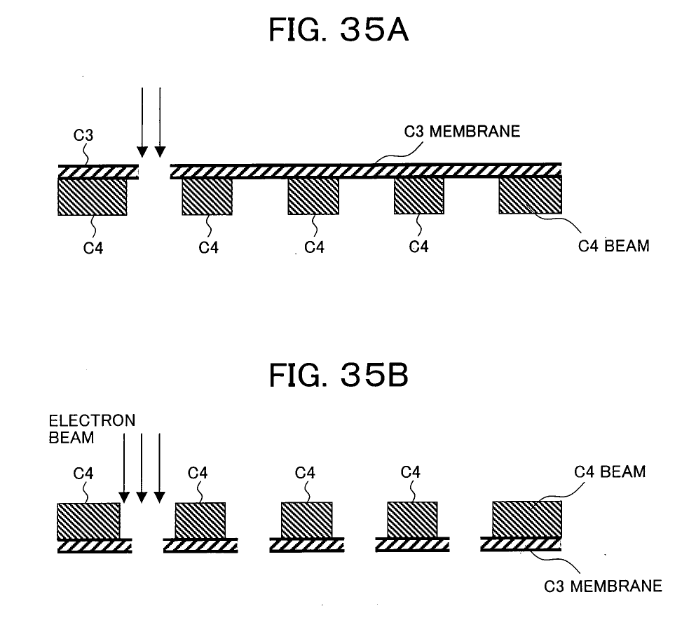

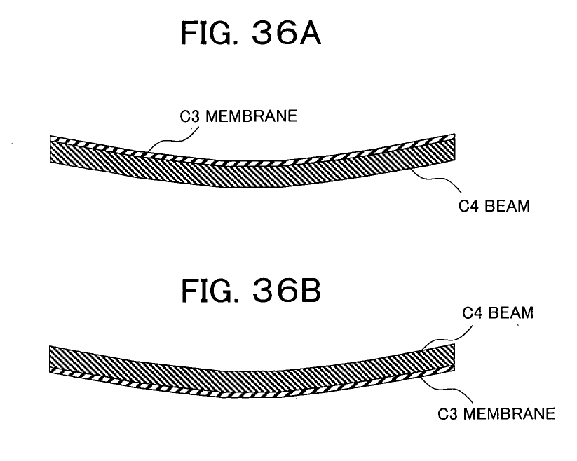

FIG. 35A is a sectional view schematically showing the stencil mask at the time of the preparation of the mask, while FIG. 35B is a sectional view schematically showing the stencil mask at the time of the usage of the mask. FIG. 36A to FIG. 36B are diagrams for explaining the correction of distortion.

At the time of the preparation of the mask, in more detail, at the time of the drawing the mask, when etching patterns on the membrane, as shown in FIG. 35A, the membrane c3 is formed so as to be located above the beams c4. At the time of usage of the mask, in more detail at the time of exposure by for example the electron beam, as shown in FIG. 35B, the mask is used inverted front/back so that the membrane c3 is located below the beam c4s.

For this reason, due to gravity, the center portion of the mask is bent downward so that the surface facing the beam side surface of the membrane c3 sinks down at the time of fabrication of the mask as shown in FIG. 36A, while the center portion of the mask is bent in the downward direction so that the beam side surface of the membrane c3 sinks down due to the front/back inversion at the time of the usage of the mask as shown in FIG. 36B. Therefore, the mask inversion correction unit 1611 performs the processing for correction of distortion due to the change of the bending based on the data indicating the mechanical characteristics of the mask included in the data parameters 152 and the complementary pattern data verified by the exposure verification unit 1610.

In more detail, the distortion due to this mask inversion does not depend upon the patterns in the membrane, therefore the displacement amount is applied to the patterns in each membrane from the distortion profile prepared as a result of analyzing the distortion amount due to the mask structure or the result by experiments. When there is no front/back inversion at the time of fabrication of the mask and the time of usage of the mask, it is not necessary to perform this processing.

The correction result verification unit 1612 verifies if the processing result becomes the correct patterns as the result of the mask inversion correction by the mask inversion correction unit 1611 based on the design data 151 and the parameters 152. The correction amount is analyzed by simulation, therefore it is clear that the results become the same even if the same simulation is used.

The correction result verification unit 1612 according to the present embodiment simulates the distortion correction by using an algorithm different from the algorithm used in the mask inversion correction processing for verification. By this, verification having a high reliability becomes possible.

In more detail, the correction result verification unit 1612 compares the corrected design data with the original design data 151 based on the results of simulation under conditions of mask distortion and the membrane distortion and judges whether or not the difference is within the range of the precision. When it is within the range of precision, the correction result verification unit 1612 outputs the corrected stencil mask data generated by the above series of processing to the data conversion unit 1613.

The data conversion unit 1613 generates the drawing membrane data d16131 for making the mask preparation device 4 shown in for example FIG. 1 prepare the membrane and the drawing pattern data d16132 for making the mask preparation device 4 prepare the patterns based on the data for generating the membrane output from the membrane shape design unit 1602 and the corrected stencil mask data output from the correction result verification unit 1612 and the parameters 152 and outputs the same. At this time, the drawing pattern data d16132 includes the mask alignment marks d16011.

In more detail, the data conversion unit 1613 generates the drawing membrane data d16131 for making the mask preparation device 4 draw on (dig in) the membrane from the silicon wafer under the control of for example the mask preparation processing device 3 and generates the drawing pattern data d16132 for drawing the complementarily divided patterns in the membrane c3. The CPU 16 outputs the generated drawing membrane data d16131 and drawing pattern data d16132 via for example the I/F 13 and communication network NET 7 to the mask preparation processing device 3.

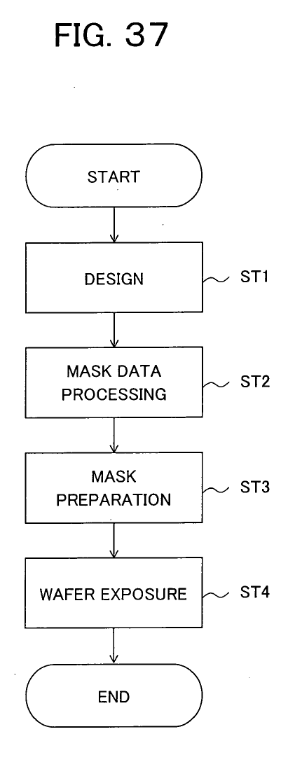

FIG. 37 is a flow chart showing the operation of the mask processing system 100 shown in FIG. 1. The operation of the mask processing system 100 will be explained by referring to FIG. 37.

At step ST1, for example, the design processing device 2 generates the design data 151 of a desired semiconductor integrated circuit and outputs the same via the communication network NET 7 to the mask processing apparatus 1.

At step ST2, the mask processing apparatus 1 generates the complementary stencil mask data, in more detail, the drawing membrane data d16131 and the drawing pattern data d16132 based on the mask characteristic data indicating the characteristics of the stencil mask including the design data 151 output from the design processing device 2, the device characteristic pattern for the mask preparation device 4, the device characteristic parameters for the exposure apparatus 6, etc. and outputs the same via the network NET 7 to the mask preparation processing device 3.

At step ST3, the mask preparation processing device 3 controls the mask preparation device 4 based on the drawing membrane data d16131 and the drawing pattern data d16132 and makes it actually generate for example the complementary stencil mask c1 as shown in FIG. 7. At this time, mask alignment marks are also formed in the complementary stencil mask.

At step ST4, the exposure processing device 5 controls the exposure apparatus 6, performs alignment based on the mask alignment marks and the wafer alignment marks using the generated complementary stencil mask c1, and exposes the circuit patterns in accordance with the desired design data onto the silicon wafer by multiple exposure by an electron beam. Thereafter, the etching etc. are carried out, circuit patterns are formed in accordance with the desired design patterns on the silicon wafer, the wafer is cut, and the device is packaged etc., whereby the desired semiconductor device is generated.

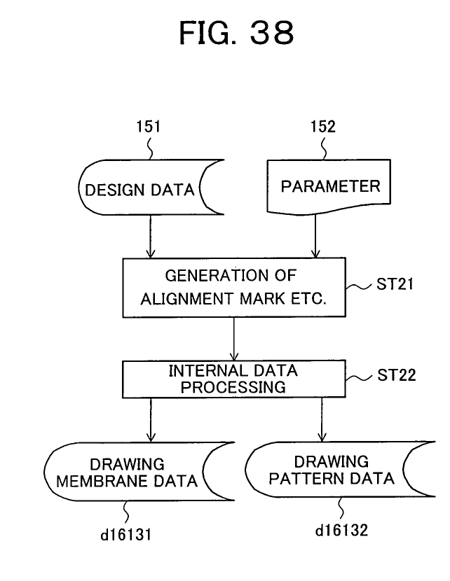

FIG. 38 is a flow chart for explaining the operation of the mask processing apparatus shown in FIG. 1. The operation of the mask processing apparatus will be simply explained by referring to FIG. 38.

At step ST21, in the mask processing apparatus 1, for example the alignment mark generation unit 1601 generates the alignment marks etc. based on the design data 151 and the parameters 152.

At step ST22, the mask processing apparatus 1 performs the above-explained internal data processing based on the generated alignment data, design data 151, and parameters 152 and generates the complementary mask pattern data, in more detail the drawing membrane data d16131 and the drawing pattern data d16132.

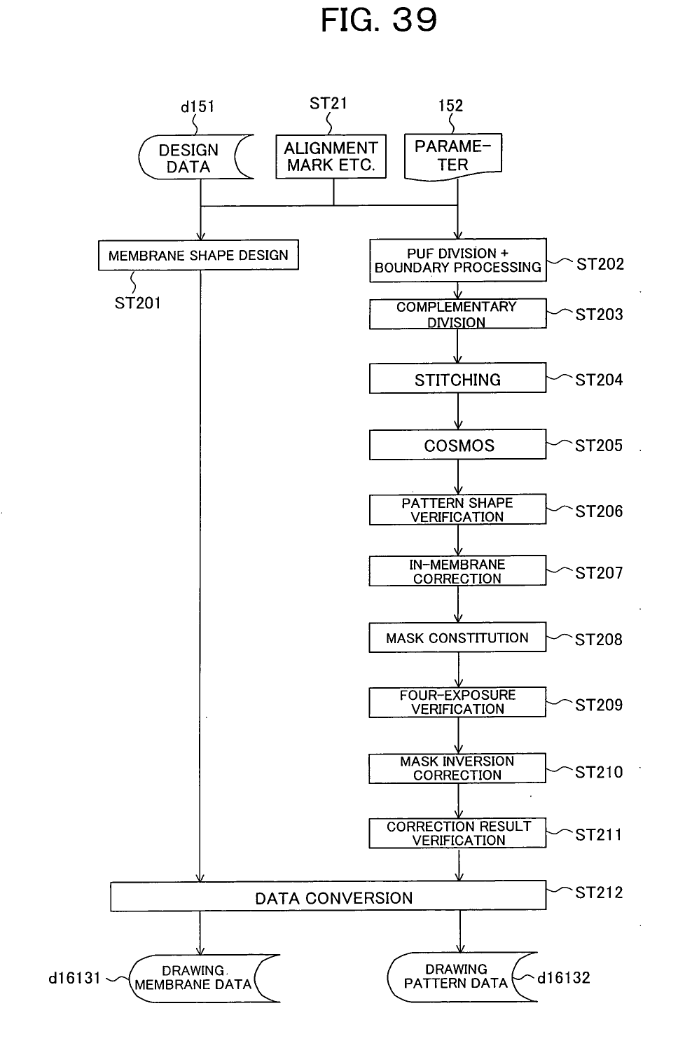

FIG. 39 is a flow chart for explaining the operation of the mask processing apparatus shown in FIG. 1. The operation of the mask processing apparatus 1 will be simply explained focusing on the operation of the CPU 16 by referring to FIG. 39.

At step ST201, the membrane shape design unit 1602 generates data for generating the membrane based on the alignment marks d1601 generated by the alignment mark generation unit 1601 at step ST21 as explained above, the design data 151, and the parameters 152 and outputs the same to the data conversion unit 1613.

At step ST202, the PUF and boundary processing unit 1603 performs the PUF division processing and the boundary processing based on the design data 151, parameters 152, and alignment marks d1601. At this time, as explained above, the design data 151 is subjected to the boundary processing of PUF and decomposed to PUFs.

The complementary division unit 1604 performs the complementary division processing based on the design data 151 PUF decomposed by the PUF and boundary processing unit 1603, and the parameters 152 (ST203), the stitching portion 1605 performs the predetermined processing for addition of patterns to the cut portion at the PUF division processing and the cut portion at the complementary division processing (ST204), and the COSMOS layout unit 1606 arranges the complementarily divided pattern data in sections of the stencil mask c1 based on the map data (layout data) in accordance with the mask shape included in the parameters 152 (ST205).

At step ST206, the pattern shape verification unit 1607 verifies whether or not the complementary pattern for each membrane arranged by the COSMOS layout 205 can be formed on the membrane c1. The in-membrane correction unit 1608 calculates the displacement amount occurring when forming holes in accordance with the complementary pattern verified by the pattern shape verification unit 1607 in the membrane c3 in accordance with the design data 151 and the parameters 152 and corrects the complementary stencil mask data so as to obtain the desired patterns as a result of the displacement in accordance with the calculation result (ST207).

At step ST208, the mask configuration unit 1609 performs the correction inside the membrane for one chip based on the data corrected by the in-membrane correction unit 1608 and the parameters 152 and arranges the corrected chip in accordance with the mask constitution. The exposure verification unit 1610 verifies for layout mistakes and whether or not the intended design data is obtained when the constituted COSMOS mask is exposed four times based on the mask constitution generated by the above mask configuration unit 1609 (ST209).

At step ST210, the mask inversion correction unit 1611 performs processing for correction of distortion due to the change of the bending based on the data indicating the mechanical characteristics of the mask included in the data parameters 152 and the complementary pattern data verified by the exposure verification unit 1610. The correction result verification unit 1612 verifies whether or not the processing result gives the correct patterns based on the design data 151 and the parameters 152 as a result of the mask inversion correction processing by the mask inversion correction unit 1611 (ST211).

At step ST212, the data conversion unit 1613 generates for example the drawing membrane data d16131 for making the mask preparation device 4 shown in FIG. 1 prepare the membrane and the drawing pattern data d16132 for making the mask preparation device 4 prepare patterns based on the data for generating the membrane output from the membrane shape design unit 1602, the correction stencil mask data output by the correction result verification unit 1612, and the parameters 152.

As explained above, by executing the mask data processing routine, the desired complementary stencil mask can be generated easily and with a high reliability based on the design data 151 and the mask characteristic data 152 indicating the characteristics of the mask.

Further, the method of use is easy, and human error can be prevented by automatically performing all of the processing.

Further, by performing the PUF division and layout processing by fixed routines, a large scale chip can be processed.

Further, the four-exposure type complementary mask can be easily generated based on the layout data.

Note that the present invention is not limited to the present embodiment. Various preferred modifications are possible.

For example, the processing routines according to the present embodiment are not limited to the above-explained sequence. For example, the predetermined verification processing and correction processing may be executed in the sequence giving the desired results.

According to the present invention, a mask processing apparatus, mask processing method, program and mask enabling easy preparation of the mask used in a charged particle beam exposure apparatus can be provided.

### INDUSTRIAL APPLICABILITY

The mask processing apparatus, mask processing method, program and mask of the present invention can be used for processing a mask used in for example a lithography process of a semiconductor production apparatus.

1. A mask processing apparatus generating complementary stencil mask data,
said mask processing apparatus comprising:
a complementary dividing means for complementarily dividing design data for each predetermined processing unit to generate complementarily divided patterns based on the design data and mask characteristic data indicating at least the characteristics of the complementary stencil mask; and
a mask data generating means for generating the complementary stencil mask data based on the complementarily divided patterns generated by the complementary dividing means and mask characteristic data.

2. A mask processing apparatus as set forth in claim 1, wherein
said mask characteristic data includes beam position data of beams formed in said complementary stencil mask,
said complementary dividing means generates said complementarily divided patterns based on said design data and said beam position data in said mask characteristic data, and
said mask data generating means generates the complementary stencil mask data based on the complementarily divided patterns generated by the complementary dividing means and said beam position data in said mask characteristic data.

3. A mask processing apparatus as set forth in claim 1, wherein said mask data generating means has a shape verifying means for verifying whether defect patterns have been generated on said complementary stencil mask based on said complementarily divided patterns which said complementary dividing means generates for each said predetermined processing unit.

4. A mask processing apparatus as set forth in claim 1, wherein said mask data generating means has correcting means for performing displacement correction processing on at least said complementarily divided patterns using internal stress of the membrane in said complementary stencil mask based on said complementarily divided patterns generated by said complementary dividing means and said mask characteristic data and generating said complementary stencil mask data based on results of said displacement correction processing.

5. A mask processing apparatus as set forth in claim 1, wherein said mask data generating means has correcting means for performing displacement correction processing on at least said complementarily divided patterns using mechanical characteristics of the mask members of said complementary stencil mask based on said complementarily divided patterns generated by said complementary dividing means and said mask characteristic data and generating said complementary stencil mask data based on results of said displacement correction processing.

6. A mask processing apparatus as set forth in claim 1, wherein said mask data generating means has inversion correcting means for performing displacement correction processing on at least said complementarily divided patterns using front/back inversion of said complementary stencil mask based on said complementarily divided patterns generated by said complementary dividing means and said mask characteristic data and generating said complementary stencil mask data based on results of said displacement correction processing.

7. A mask processing apparatus as set forth in claim 1, wherein said mask data generating means has exposure verifying means for verifying if said complementarily divided patterns coincide with patterns in said design data by a plurality of exposures based on said complementarily divided patterns generated by said complementary dividing means and said mask characteristic data and generating said complementary stencil mask data based on results of said verification.

8. A mask processing apparatus as set forth in claim 1, further comprising a membrane data generating means for generating membrane data for drawing the shape of said membrane in said complementary stencil mask based on said design data and said mask characteristic data.

9. A mask processing apparatus as set forth in claim 1, wherein
said mask characteristic data includes device characteristic data relating to characteristics of the stencil mask generation device for generating said complementary stencil mask, and
said apparatus further comprises a drawing data generating means for generating drawing membrane data for making said stencil mask generation device draw said membrane and drawing pattern data for making it draw said complementarily divided patterns in said membrane based on said membrane data generated by said membrane data generating means, complementary stencil mask data generated by said mask pattern data generating means, and said device characteristic data.

10. A mask processing apparatus as set forth in claim 1, wherein
said apparatus comprises an alignment data generating means for generating at least alignment data for said stencil mask based on said design data and said mask characteristic data, and
said mask data generating means generates said complementary stencil mask data including said alignment data generated by said alignment data generating means.

11. A mask processing method of a mask processing apparatus for generating complementary stencil mask data,
said mask processing method including:
a first step of complementarily dividing design data for each predetermined processing unit to generate complementarily divided patterns based on the design data and mask characteristic data indicating at least the characteristics of a complementary stencil mask; and
a second step of generating complementary stencil mask data based on the complementarily divided patterns generated in the first step and the mask characteristic data.

12. A mask processing method as set forth in claim 11, wherein
said mask characteristic data includes beam position data of beams formed in said complementary stencil mask,
said first step generates said complementarily divided patterns based on said design data and said beam position data in said mask characteristic data, and
said second step generates the complementary stencil mask data based on the complementarily divided patterns generated by said first step and said beam position data in said mask characteristic data.

13. A mask processing method as set forth in claim 11, wherein said second step has a step of verifying whether defect patterns have been generated on said complementary stencil mask based on said complementarily divided patterns which said first step generates for each said predetermined processing unit.

14. A mask processing method as set forth in claim 11, wherein said second step has a step of performing displacement correction processing on at least said complementarily divided patterns using internal stress of the membrane in said complementary stencil mask based on said complementarily divided patterns generated by said first step and said mask characteristic data and generating said complementary stencil mask data based on results of said displacement correction processing.

15. A mask processing method as set forth in claim 11, wherein said second step has a step of performing displacement correction processing on at least said complementarily divided patterns using mechanical characteristics of the mask members of said complementary stencil mask based on said complementarily divided patterns generated at said first step and said mask characteristic data and generating said complementary stencil mask data based on results of said displacement correction processing.

16. A mask processing method as set forth in claim 11, wherein said second step has a step of performing displacement correction processing on said complementarily divided patterns using front/back inversion of said complementary stencil mask based on said complementarily divided patterns generated at said first step and said mask characteristic data and generating said complementary stencil mask data based on results of said displacement correction processing.

17. A mask processing method as set forth in claim 11, wherein said second step has a step of verifying if said complementarily divided patterns coincide with patterns in said design data by a plurality of exposures based on said complementarily divided patterns generated at said first step and said mask characteristic data and generating said complementary stencil mask data based on results of said verification.

18. A mask processing method as set forth in claim 11, wherein
said mask characteristic data includes device characteristic data relating to characteristics of a stencil mask generation device for generating said complementary stencil mask,
said first step includes a step of generating membrane data for drawing the shape of said membrane in said complementary stencil mask based on said design data and said mask characteristic data, and
said method further has, after said second step, a step of generating drawing membrane data for making said stencil mask generation device draw said membrane and drawing pattern data for making it draw said complementarily divided patterns in said membrane based on said membrane data, said complementary stencil mask data, and said device characteristic data.

19. A mask processing method as set forth in claim 11, wherein
said first step includes a step of generating at least alignment data for said stencil mask based on said design data and said mask characteristic data, and
said second step generates said complementary stencil mask data including said alignment data.

20. A mask processing method of a mask processing apparatus for generating complementary stencil mask data,
said mask processing method including:
a first step of complementarily dividing design data for each predetermined processing unit to generate complementarily divided patterns based on design data and mask characteristic data including at least beam position data of beams and device characteristic data concerning the characteristic of a stencil mask generation device for generating a complementary stencil mask and indicating the characteristics of the complementary stencil mask;
a second step of generating membrane data for drawing the shape of the membrane in the complementary stencil mask based on the design data and the mask characteristic data;
a third step of arranging the complementarily divided patterns at predetermined positions of the stencil mask based on the complementarily divided patterns generated for each predetermined processing unit by the first step and the mask characteristic data;
a fourth step of verifying whether or not defect patterns have been generated on the complementary stencil mask based on the complementarily divided patterns arranged at the third step;
a fifth step of performing displacement correction processing on the complementarily divided patterns using internal stress of the membrane in the complementary stencil mask;
a sixth step of performing the displacement correction processing for the complementarily divided patterns using the mechanical characteristics of a mask member of the complementary stencil mask;
a seventh step of verifying whether or not the complementarily divided patterns coincide with patterns in the design data by a plurality of exposures,
an eighth step of performing the displacement correction processing on the complementarily divided patterns using front/back inversion of the complementary stencil mask to generate complementary stencil mask data;
a ninth step of verifying whether or not the complementarily divided patterns coincide with patterns in the design data based on the complementary stencil mask data generated by the eighth step and the design data; and
a 10th step of generating drawing membrane data for making the stencil mask generation device draw the membrane and draw the complementarily divided patterns in the membrane based on the membrane data, the complementary stencil mask data, and the device characteristic data.

21. A program to be executed by an information processing apparatus,
said program comprising:
a first routine of complementarily dividing design data for each predetermined processing unit to generate complementarily divided patterns based on the design data and mask characteristic data indicating at least the characteristics of a complementary stencil mask; and
a second routine of generating complementary stencil mask data based on the complementarily divided patterns generated at the first routine and the mask characteristic data.

22. A program as set forth in claim 21, wherein
said mask characteristic data includes beam position data of beams formed in said complementary stencil mask,
said first routine generates said complementarily divided patterns based on said design data and said beam position data in said mask characteristic data, and
said second routine generates the complementary stencil mask data based on the complementarily divided patterns generated by said first routine and said beam position data in said mask characteristic data.

23. A program as set forth in claim 21, wherein said second routine has a routine of verifying whether defect patterns have been generated on said complementary stencil mask based on said complementarily divided patterns which said first routine generates for each said predetermined processing unit.

24. A program as set forth in claim 21, wherein said second routine has a routine of performing displacement correction processing on at least said complementarily divided patterns using internal stress of the membrane in said complementary stencil mask based on said complementarily divided patterns generated by said first routine and said mask characteristic data and generating said complementary stencil mask data based on results of said displacement correction processing.

25. A program as set forth in claim 21, wherein said second routine has a routine of performing displacement correction processing on at least said complementarily divided patterns using mechanical characteristics of the mask members of said complementary stencil mask based on said complementarily divided patterns generated at said first routine and said mask characteristic data and generating said complementary stencil mask data based on results of said displacement correction processing.

26. A program as set forth in claim 21, wherein said second routine has a routine of performing displacement correction processing on said complementarily divided patterns using front/back inversion of said complementary stencil mask based on said complementarily divided patterns generated at said first routine and said mask characteristic data and generating said complementary stencil mask data based on results of said displacement correction processing.

27. A program as set forth in claim 21, wherein said second routine has a routine of verifying if said complementarily divided patterns coincide with patterns in said design data by a plurality of exposures based on said complementarily divided patterns generated at said first routine and said mask characteristic data and generating said complementary stencil mask data based on results of said verification.

28. A mask program as set forth in claim 21, wherein
said mask characteristic data includes device characteristic data relating to characteristics of a stencil mask generation device for generating said complementary stencil mask,
said first routine includes a routine of generating membrane data for drawing the shape of said membrane in said complementary stencil mask based on said design data and said mask characteristic data, and
said program further has, after said second routine, a routine of generating drawing membrane data for making said stencil mask generation device draw said membrane and drawing pattern data for making it draw said complementarily divided patterns in said membrane based on said membrane data, said complementary stencil mask data, and said device characteristic data.

29. A program as set forth in claim 21, wherein
said first routine includes a routine of generating at least alignment data for said stencil mask based on said design data and said mask characteristic data, and
said second routine generates said complementary stencil mask data including said alignment data.

30. A program to be executed by an information processing apparatus,
said program comprising:
a first routine of complementarily dividing design data for each predetermined processing unit to generate complementarily divided patterns based on the design data and mask characteristic data including at least beam position data of beams and device characteristic data concerning the characteristics of a stencil mask generation device for generating the complementary stencil mask and indicating the characteristics of the complementary stencil mask;
a second routine of generating membrane data for drawing the shape of the membrane in the complementary stencil mask based on the design data and the mask characteristic data;
a third routine of arranging the complementarily divided patterns at predetermined positions of the stencil mask based on the complementarily divided patterns generated for each predetermined processing unit by the first routine and the mask characteristic data;
a fourth routine of verifying whether or not a defect pattern is generated on the complementary stencil mask based on the complementarily divided patterns arranged in the third routine;
a fifth routine of performing displacement correction processing on the complementarily divided patterns using internal stress of the membrane in the complementary stencil mask;
a sixth routine of performing displacement correction processing on the complementarily divided patterns using mechanical characteristics of a mask member of the complementary stencil mask;
a seventh routine of verifying whether or not the complementarily divided patterns coincide with patterns in the design data by a plurality of exposures;
an eighth routine of generating the complementary stencil mask data by performing displacement correction processing on the complementarily divided patterns using front/back inversion of the complementary stencil mask;
a ninth routine of verifying whether or not the complementarily divided patterns coincide with patterns in the design data based on the complementary stencil mask data generated by the eighth routine and the design data; and
a 10th routine of generating drawing membrane data for making the stencil mask generation device draw the membrane and draw the complementarily divided patterns in the membrane based on the membrane data, the complementary stencil mask data, and the device characteristic data.

31. A mask generated based on complementary stencil mask data generated by a mask processing apparatus as set forth in any one of claims 1 to 8.

32. A mask generated by a stencil mask generation device based on drawing membrane data and drawing pattern data generated by a mask processing apparatus as set forth in claim 9.
